(19) United States
(12) Patent Application Publication
(10) Pub. No.: US 2002/0087441 A1
(43) Pub. Date: Jul. 4, 2002

(54) Method and apparatus for managing the allocating of financial transactions into ledger accounts

(76) Inventors: Charles Arthur Wagner JR., Glenn Arm, MD (US); Joel Friedman, Marriottsville, MD (US); Barry Kirk, Stewartstown, PA (US)

Correspondence Address: R. Lewis Gable, Cowan, Liebowitz & Latman, P.C., 1133 Avenue of the Americas, New York, NY, 10036, US

(21) Appl. No.: 09/916,398

(22) Filed: Jul. 27, 2001

Related U.S. Application Data
(60) Provisional application No. 60/221,330, filed on Jul. 28, 2000.

(51) Int. Cl. G06F 17/60

(52) U.S. Cl. 705/30

(57) ABSTRACT

Apparatus and method are disclosed for supporting a plurality of users to allocate the financial transactions of each user to a corresponding one of a plurality of ledgers. Each of the ledgers has a plurality of accounts. The apparatus comprises a memory comprising a plurality of storage locations, each of which stores a corresponding one of the ledgers for its user, and a server. The server is programmed to determine the attributes of each of the financial transactions, facilitate each of the users to construct its own allocation policy, and to allocate each financial transaction according to the allocation policy of its user into a corresponding account of that user.

### BACKGROUND OF THE INVENTION

### FIELD OF THE INVENTION

This invention relates to the allocation of Purchasing, Fleet and Travel & Entertainment Expenses against company specific general ledger accounts. The application is deployed over the internet.

### DESCRIPTION OF THE BACKGROUND OF THE INVENTION

In the corporate charge card industry most companies have a need to integrate expense transactions that are charged, for example, on an employee's credit card against their general ledger system. Most companies have specific policies or rules specifying how expenses should be allocated to specific general ledger accounts. Typically, these policies include 1) allocating by hierarchy; 2) allocating by merchant category code; 3) allocating by merchant name; 4) allocating by merchant chain; or 5) allocating by account number. In addition companies may have a need to allocate using any combination of these policies. If this is the case, the company requires the ability to set priorities on the policies.

Large companies have corporate charge card administrative staff whose job it is to set these policies and track and maintain the transactional information. They additionally have the need to split the transactions across multiple general ledger accounts.

Prior to maintaining the individual transactions, the company's master chart of general ledger accounts would need to be established in addition to a fiscal calendar. The fiscal calendar would contain the beginning and ending dates for each fiscal period.

Lastly, once all of the transactional information is maintained, there would be a need to download the data to the company's site in addition to reporting on these transactions. The layout and format of this data would need to be flexible enough to meet each company's needs.

### SUMMARY OF THE INVENTION

It is the objective of this invention to facilitate all areas of policy set up, transaction maintenance, reporting and download in regards to allocating corporate charge card purchasing data to company specific General Ledger accounts.

It is a primary objective to allow company identified employees to have the ability to set up company policy. The policy information includes, but is not limited to, 1) creation of the fiscal calendar; 2) creation of the master chart of accounts; 3) allocation set up (determine which types of transactions are allocated to specific general ledger accounts; 4) setting up the priority of the allocation process. This information is used in a nightly batch process to allocate the financial transactions to the policy defined general ledger accounts.

It is a further objective of this invention to permit a number of employees (e.g. corporate charge card administrators, charge card holders, corporate charge card managers, etc.) to have access to this data. In addition, a subset of these employees will have the ability to maintain the transactions. Specifically, they will have the ability to change the default general ledger account number for which the transaction was allocated (based on policy). In addition, the user will have the ability change the cost center and/or project for which this transaction is allocated. It is another objective to allow these users to split these transactions across multiple general ledger accounts. Cost centers and projects can be controlled at the individual split level as well. Each transaction may also contain individual “free form” notes detailing any company specific information. In accordance with these objectives it is also important to give the users “drill down” capability to view specific details around each transaction (e.g. merchant name, address, transaction details, merchant category code, date) as well as details surrounding the account (name, address, spending limits). This information is needed to intelligently make a decision when assigning a transactions to general ledger accounts.

It is another objective of this invention to report on the allocations at any time for any fiscal period.

It is an important objective of this invention to allow the end-user to have the ability to download their company's transactional data at the end of each fiscal period. This invention will allow the company to set up specific file layouts and formats for the download.

In accordance with these and other objectives of this invention, access to this data will be controlled by each company. Specifically, each company may determine who has access to the data and who can review and/or approve each transaction.

Additionally, it is also an objective to allow users to limit the amount of transactional data that they are working with by: 1) Specifying company hierarchy information (This will allow a user to view specific company division or subdivision information.); 2) Specifying cost center; 3) Specifying project; 4) Specifying reviewed transactions; and 5) Specifying approved transactions.

In accordance with these and other objects of this invention, there is described a method of allocating a plurality of financial transactions to a ledger of at least one user. The user's ledger comprises a plurality of accounts, and each financial transaction has a set of attributes. The method comprises the steps of determining the attributes of each of the plurality of financial transactions, facilitating the user's construction of its allocation policy, whereby certain of the attributes is/are correlated to corresponding ones of the plurality of the accounts, and comparing the determined attributes of each of said plurality of financial transactions with the user's allocation policy to determine the matched attributes therebetween and allocating dependent on the matched attributes each financial transaction to a corresponding account of the user's ledger.

In a further aspect of this invention, the allocation policy includes a set of instructions, each of which relates to selected of a plurality of sources. The method further comprises the step of responding to the set of instructions from a selected one of the plurality of users to communicate with and to instruct one of the sources to provide the set of instructions for allocation to the ledger of the one user. In particular, the attribute may take the form of one or more of the following group: 1) a particular one of a plurality of users, 2) one of a plurality of costs centers to which a financial transaction is allocated, 3) one of a plurality of merchants whose services or products were involved in one of the financial transactions, and/or 4) one of a plurality of classes of merchants whose services or products were involved in the financial transactions.

In a still further aspect of this invention, the method facilitates at least one user to construct its allocation policy, whereby each of a plurality of financial transactions may be allocated to a corresponding account of a ledger of the one user. Each financial transaction comprises one or more attributes. In particular, this method facilitates one user to construct each account of the user's ledger before selecting for each account a set of one or more of the attributes to be assigned to the corresponding account. Next, a plurality of rules are constructed to be compared against each of the financial transactions. Finally, each rule is assigned to a set of attributes corresponding to one account.

In a further feature of this invention, the method facilitates a user to manage a set of its financial transactions. First, the method facilitates the user to construct a set of instructions as to how that set of the user's financial transactions are to be managed. Next, the user sets at least one fiscal period, before the method collects said financial transactions that occurred during that fiscal period. Finally, the financial transactions that occurred during the selected fiscal period are processed in accordance with the set of instructions.

In a still further aspect of this invention, apparatus is disclosed for supporting a plurality of users to allocate the financial transactions of each user to a corresponding one of a plurality of ledgers. Each of the ledgers has a plurality of accounts. The apparatus comprises a memory comprising a plurality of storage locations, each of which stores a corresponding one of the ledgers for its user, and a server. The server is programmed to determine the attributes of each of the financial transactions, facilitate each of the users to construct its own allocation policy, and to allocate each financial transaction according to the allocation policy of its user into a corresponding account of that user.

In a still further aspect of this invention, apparatus supports each user to manage the card transactions made by its employees. Each user has its own computer terminal that is connected to and by a network to this apparatus. The employees use a plurality of cards distributed by at least one card issuer. The apparatus comprises a memory with a plurality of storage locations, each storage location storing a corresponding card transactions of its user, and a server. The server is coupled to the network and is programmed to respond to a message from a particular user's terminal bearing a set of the user's instructions of how to process its card transactions and to download and store card transactions made by the employees of that user into a storage location of the memory corresponding to that user. The server is also programmed to process the downloaded card transactions of a particular user in accordance with the instructions of that user.

### BRIEF DESCRIPTION OF THE DRAWINGS

The foregoing objects and advantages of the present invention may be more readily understood by one skilled in the art with reference being had to the following detailed description of a preferred embodiment thereof, taken in conjunction with the accompanying drawings wherein like elements are designated by identical reference numerals throughout the several views, and in which:

FIG. 1 is a network topology diagram showing how the various physical parts of the system of the present invention are interconnected with each other to implement this invention.

FIG. 2 is a diagram showing how the various internal components of the computing device are interconnected with each other to implement this invention.

FIG. 3 is a data flow diagram, showing progression of data from the external card processor to the central data repository of the present invention.

FIG. 4 is an overview diagram of the present invention. It depicts the creation of the company policy that will influence how all transactions are processed.

FIGS. 4a, b, c and d are flow diagrams of key setting components of the data management process of the present invention, which determines the granularity of the information displayed

FIGS. 5a, b and c are the entity relationship diagrams depicting each field comprising external source files entering the inventive system.

FIGS. 6-36 illustrate the screens that are displayed to an user in the course of effecting the general ledger setup, allocation and reporting processes.

### DETAILED DESCRIPTION OF A PREFERRED EMBODIMENT OF THE INVENTION

The present invention provides in an illustrative embodiment of this invention an apparatus and a method for managing the inputting of corporate charge card financial transactions from external card processors into the corresponding line items of the company's general ledger (GL) account. The financial transactions are received in specific format as set by the card processors. Even if these incoming transactions and their formats may change, the historical transactions collected and managed on the inventive apparatus will not be affected.

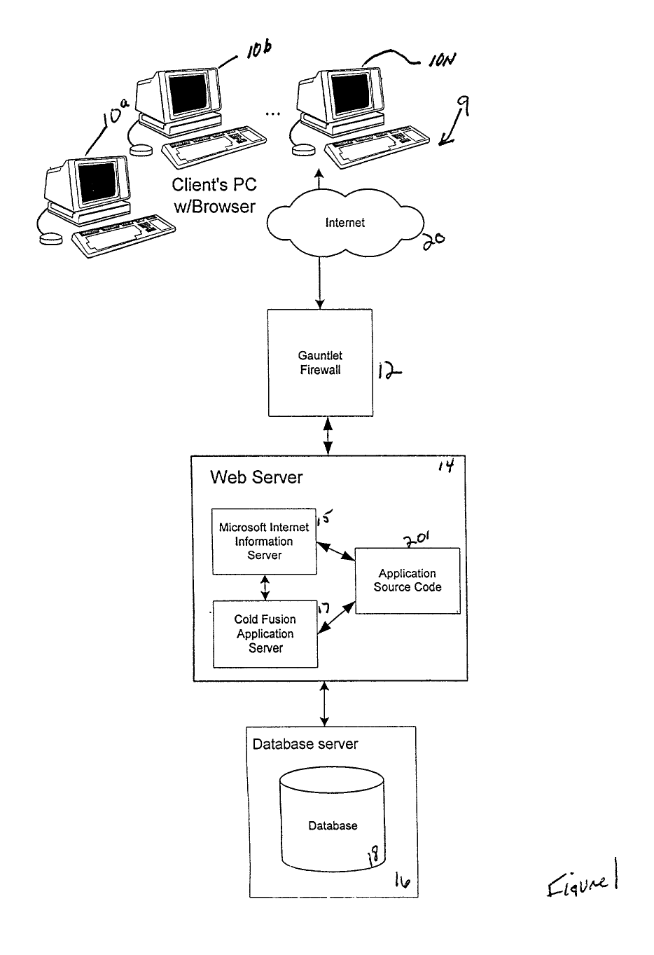

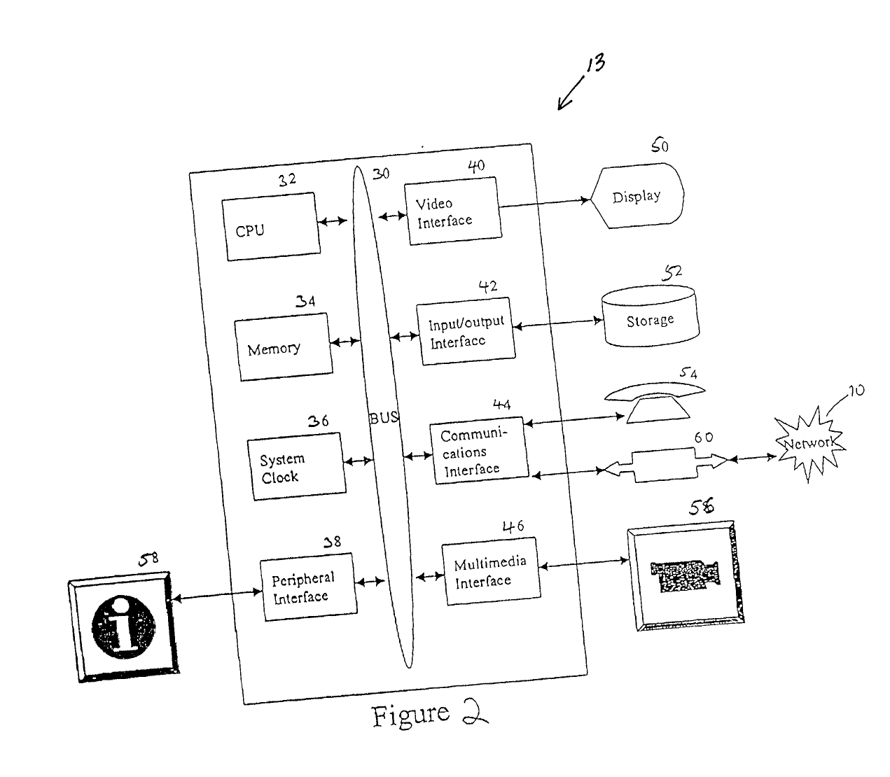

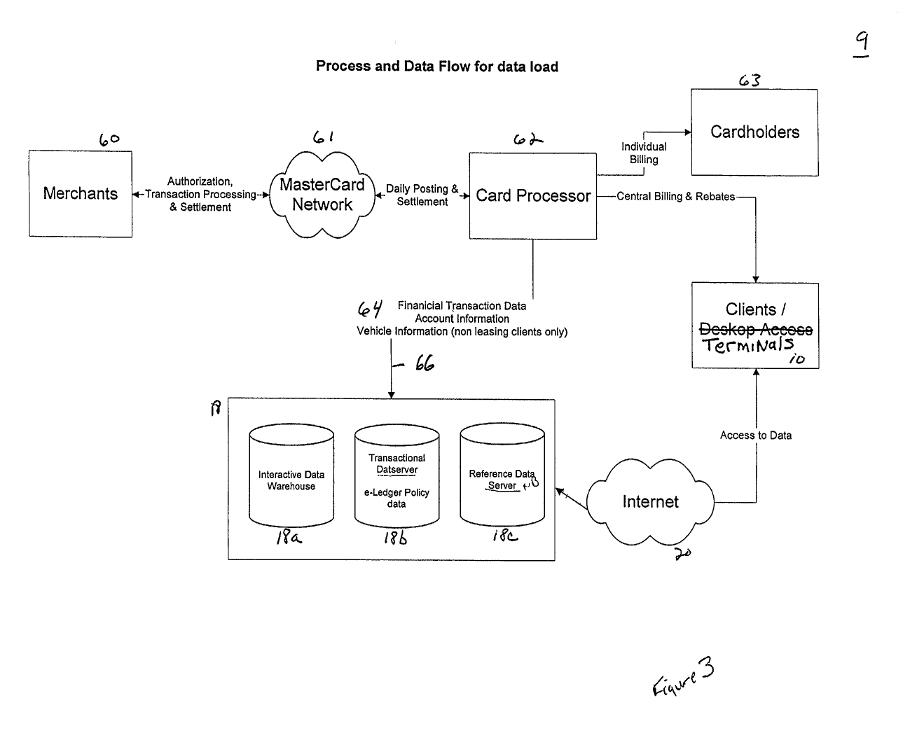

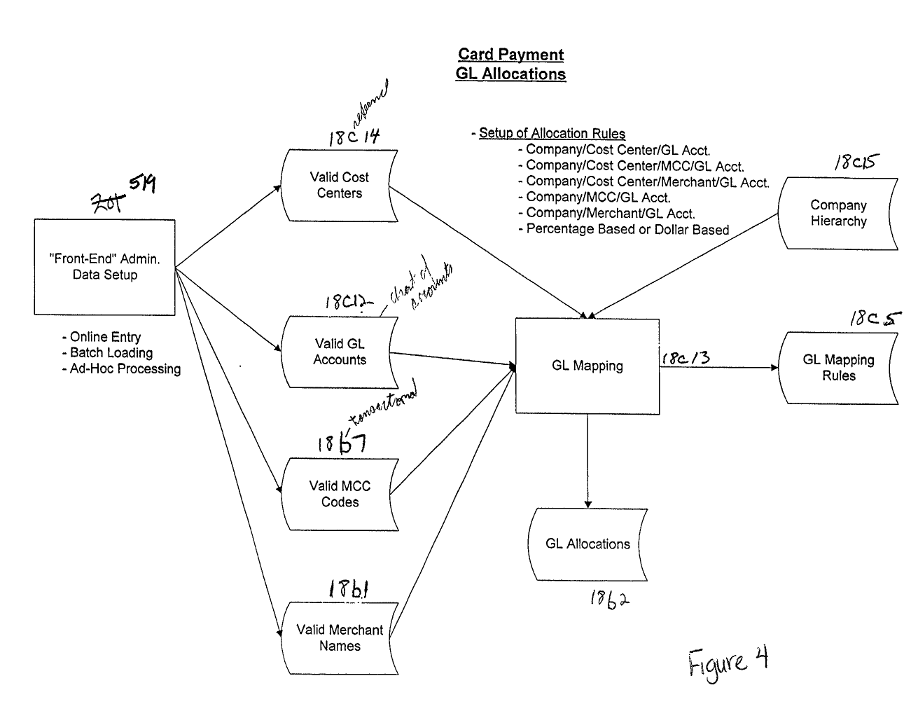

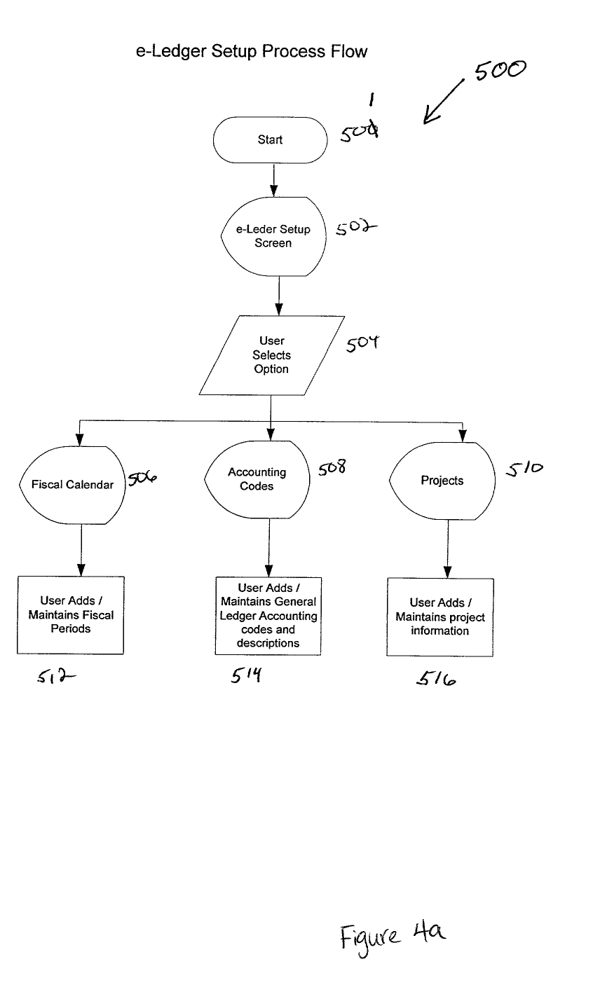

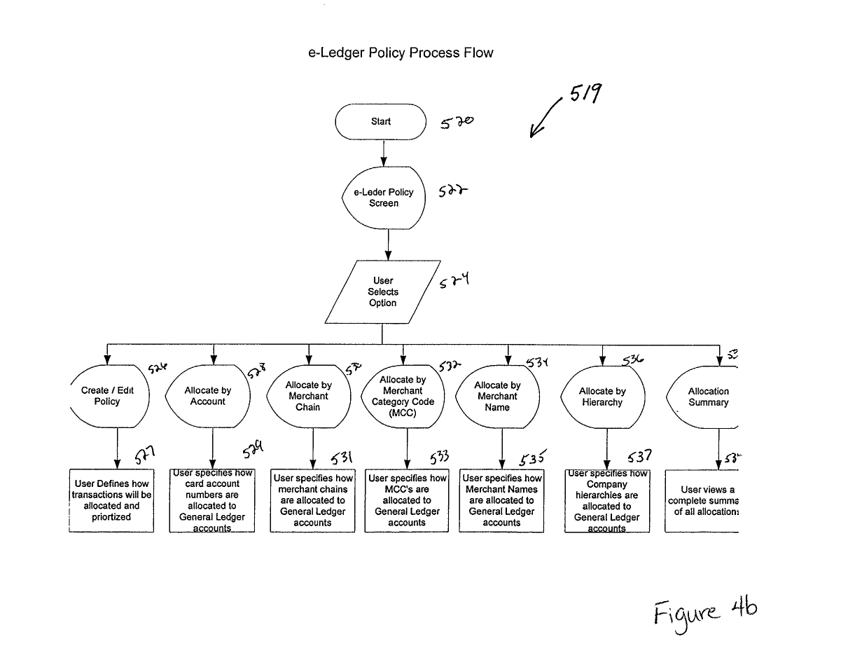

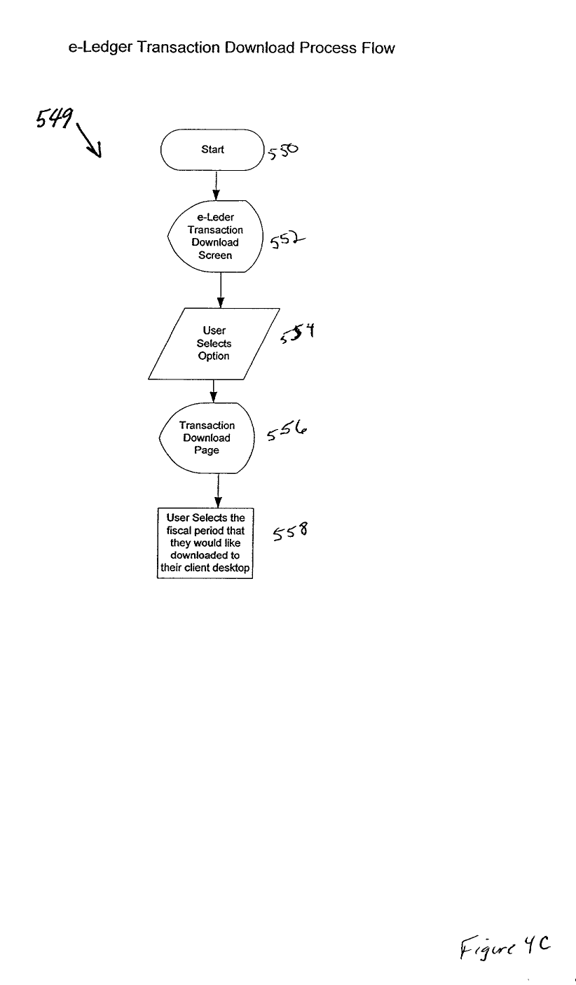

The inventive system, i.e., a ledger management system 9, may utilize in one illustrative embodiment of this invention the components shown in FIG. 1 to enable users of the invention to access and manage information related to general ledger, via a network 20, which in the preferred embodiment of this invention is the Internet. The system 9 comprises one or more computing devices 13, as shown in FIG. 2, which are used as a database server 16 for managing data storage and retrieval for the transactional, reference and reporting data bases 18, and one or more web servers 14 used for scalability and redundancy in connecting to the Internet 20. Firewalls 12, which are used to protect the infrastructure from unauthorized access, may also be included. Further, a plurality of user terminals 10a, b- - - n are connected throughout the Internet 20 to permit users to access the transactional, reference and reporting databases 18 and to set up and maintain the company specific general ledger accounting information stored therein in a manner as will be described below.

The computing devices 12, 14 and 16 and the user terminals 10 may illustratively take the configuration of any computer 13 ranging from mainframes to personal computers (PCs). In one illustrative embodiment of this invention as shown in FIG. 2, such computing devices and terminals 13 may comprise a bus 30, which is connected directly to each of the following:

1. A central processing unit (CPU) 32;

2. A memory 34;

3. A system clock 36;

4. A peripheral interface 38;

5. A video interface 40;

6. An input/output (I/O) interface 42;

7. A communications interface 44; and

8. A multimedia interface.

9. By the video interface 40 to a display 50;

10. By the I/O interface 42 to a storage device 52, which may illustratively take the form of memory gates, disks, diskettes, compact disks (CD), digital video disk (DBD), etc.;

The common bus 30 is further connected:

11. By the multimedia interface 46 to any multimedia component 56;

12. By a peripheral interface 38 to the peripherals 58, such as the keyboard, the mouse, navigational buttons, e.g., on a digital phone, a touch screen, and/or a writing screen on full size and hand held devices, e.g., a palm pilot™;

13. By the communications interface 44, e.g., a plurality of modems, to a network connection 60, e.g., an Internet Service Provider (ISP), and to other services, which is in turn connected to the network 20, whereby a data path is provided between the network 20 and the computing devices 12, 14 and 16 (FIG. 1) and, in particular, the common bus 30 of these computing devices; and

14. Furthermore, by the communications interface 44 to a wired and/or a wireless telephone system 54.

FIG. 3 shows the flow of data within the GL management system 9 to and from the database 18, which is the data source for all of the transactional data of the invention. The database 18 illustratively comprises an interactive database or data warehouse 18a, a transactional data server 18b and a reference server data server 18c. The transactional data server 18b is used to receive and store the transactional information from a card processor 62. This transactional information is immediately replicated to the interactive data warehouse 18a for reporting purposes. The reference data server 18c is used to receive and store reference data. Reference data is defined as any card or account related data that describes or otherwise established a relationship between the card and the account. Specifically, company 18c16, hierarchy 18c15 and account 18c14, as shown in FIGS. 4 and 5c, are the reference tables for this invention.

FIG. 3 also shows the initial creation and/or daily/weekly/monthly building of the databases 18a, b and c. The design and creation of the databases 18a, b and c, specifically the transactional database 18b, are intended to provide enhanced data management for integration purposes. Specifically, the data received from the card processor 62 is loaded directly to the transactional and references databases 18b and 18c. This information is immediately replicated to the reporting or interactive database 18a. Many of the features that are built into the architecture of the databases 18a, b and c include:

1. Ability to retain data for a time period longer than the period of retention provided by the card processor 62.

2. Strategic use of controlled redundancy, i.e., replication of the data stored in the transactional and reference databases 18b and 18c data to the data warehouse database 18a, to increase performance of the interactive system and to simplify its use.

3. Indexing designed specifically to facilitate the reporting process. Creating table indexes increases performance and speed of this ledger application.

In particular, individual merchants 60 collect and send the transactional data of a particular credit card, e.g., a Master Card, across the card processing network 61 to the card processor 62 for daily postings and settlements. After the transaction data is posted, the database 18 receives a data file 64 to be received and stored in the transactional and reference databases 18b and c. This data file 64 is transmitted via a data transmission path 66 directly from the current card processor 62. This data, as entered into the transactional database 18b, will be used to generate ledger allocations against specific accounts or categories of the general ledger. Further, FIG. 3 shows that the card processor 62 provides individual bills to card holder terminals 63 or to a central client billing terminal 10 (i.e. the client may illustratively be a corporation or business entity), which receives the bills, not the individual card holders using the terminal 63. This billing feature is client defined. In addition, the invention allows for clients to have desktop access via their terminals 10 to the services of the ledger management system 9.

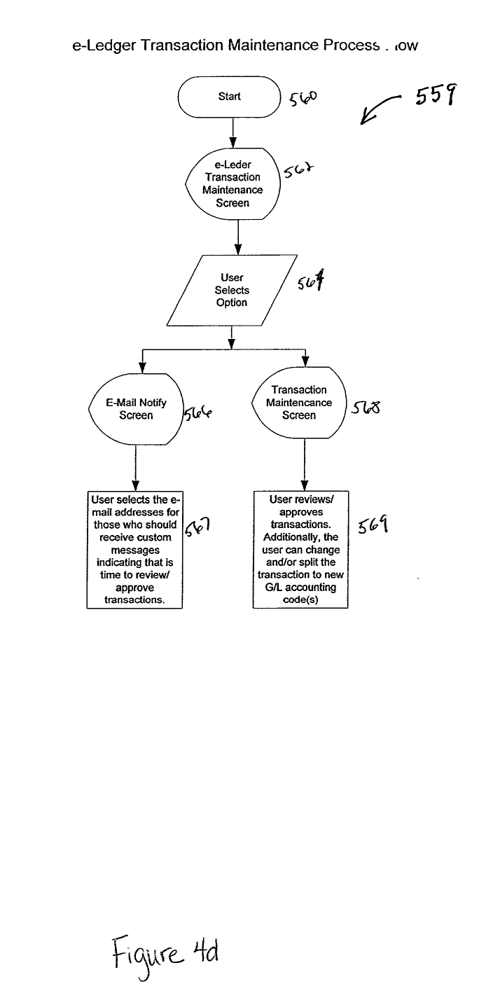

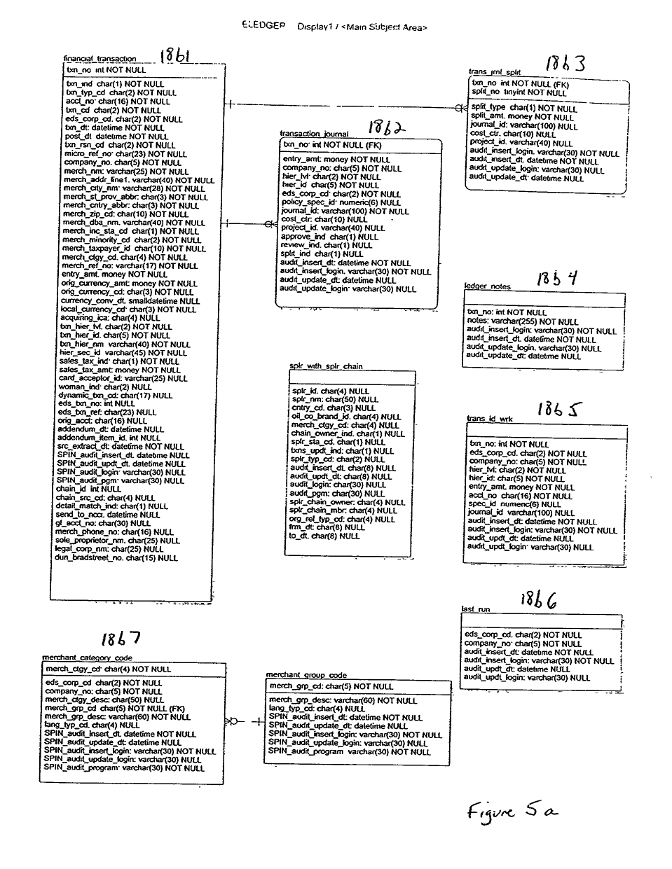

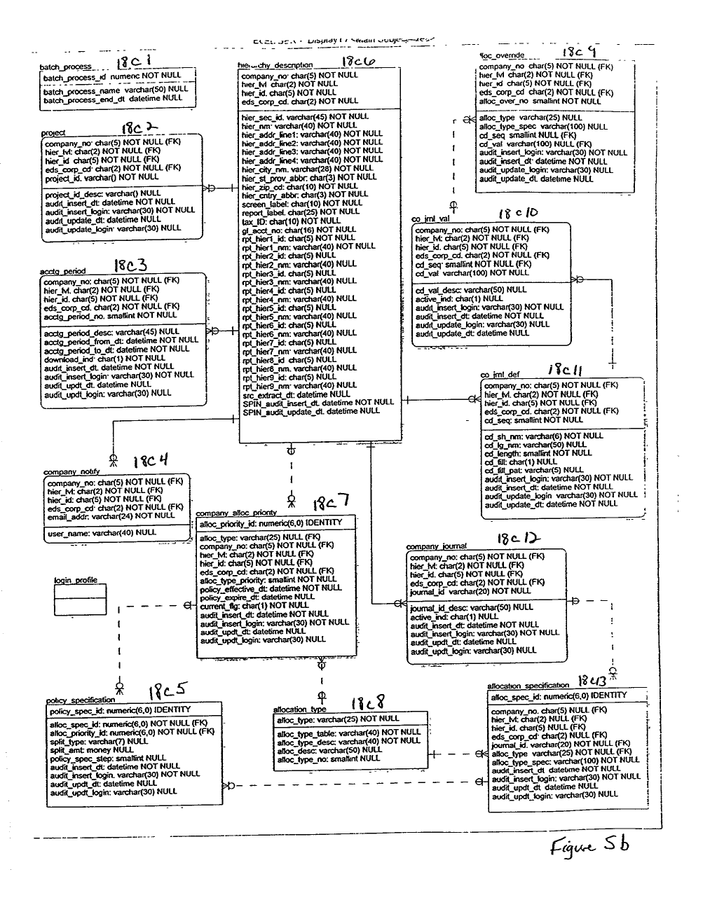

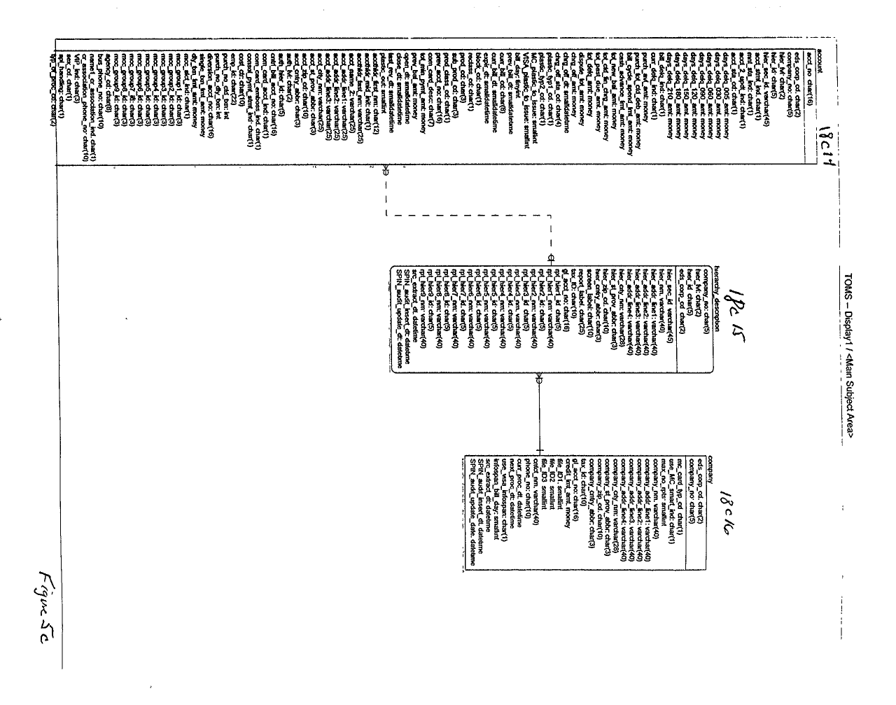

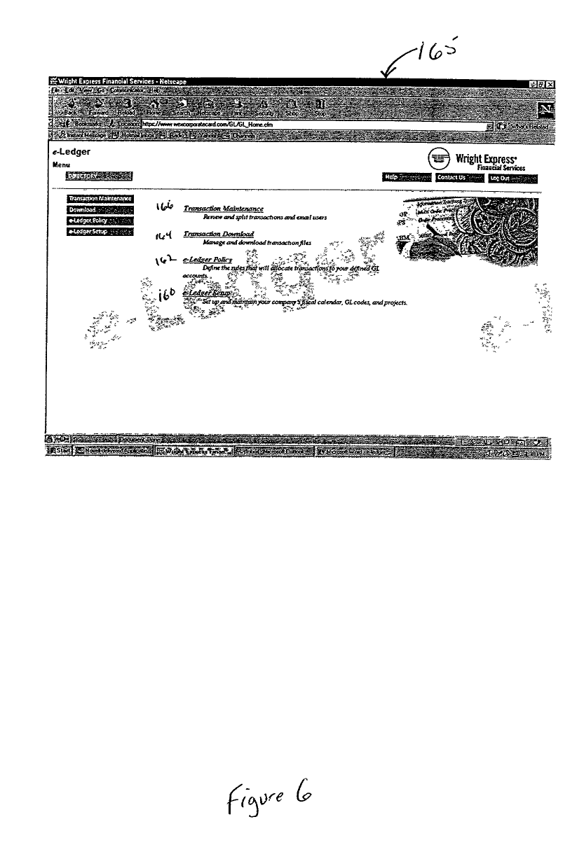

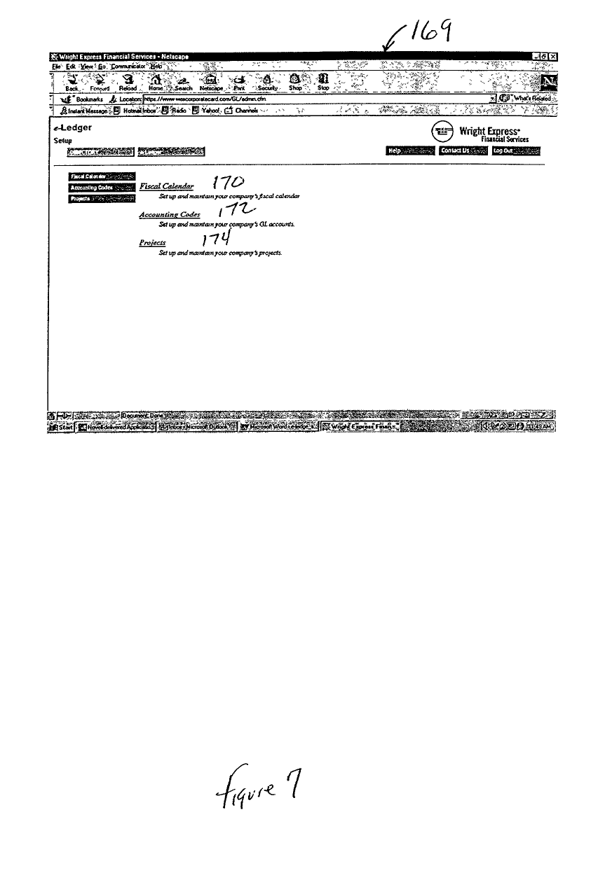

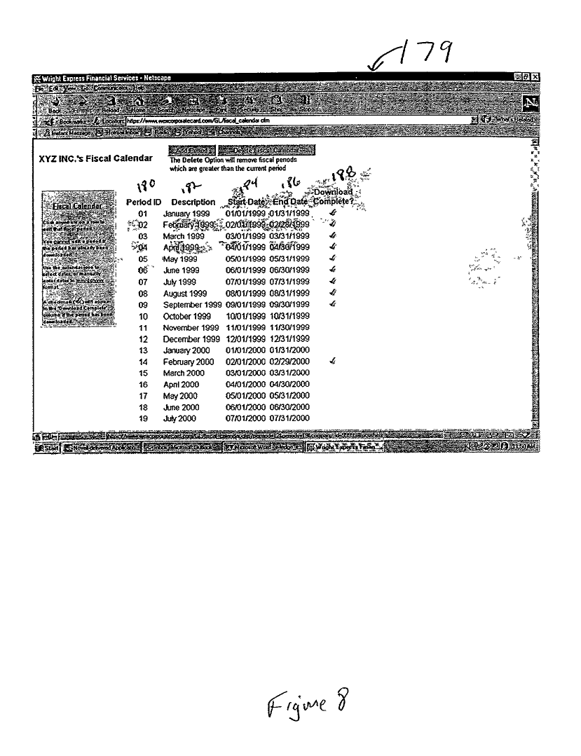

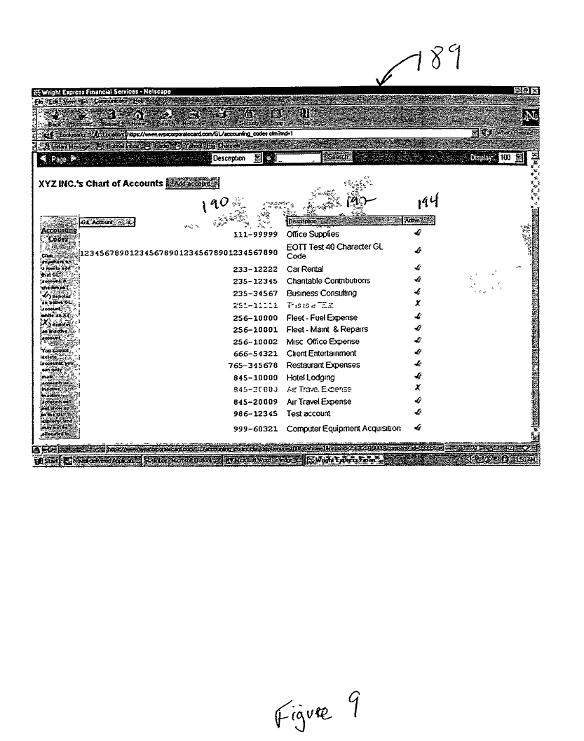

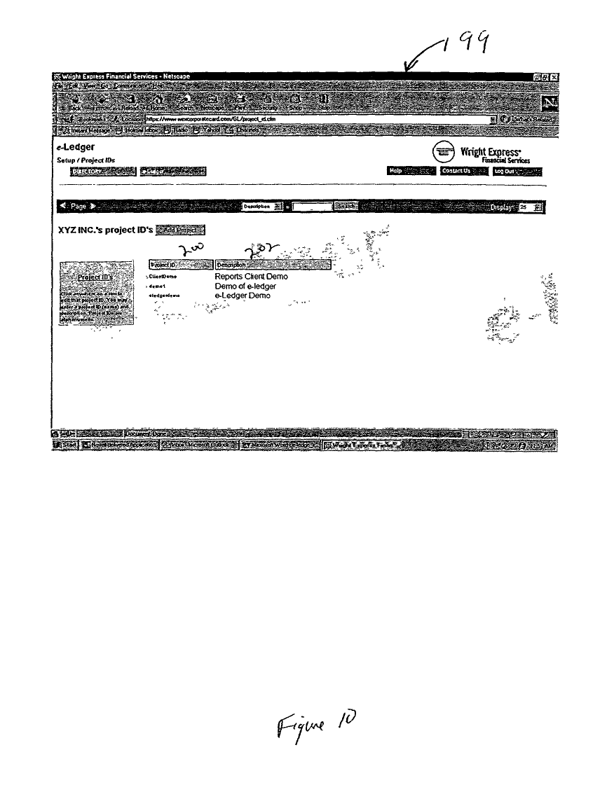

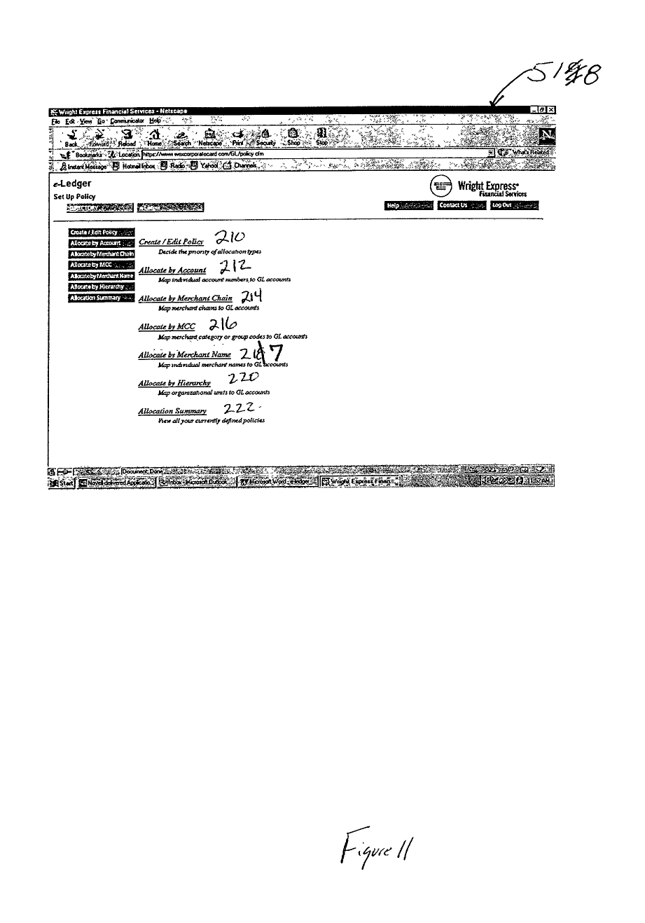

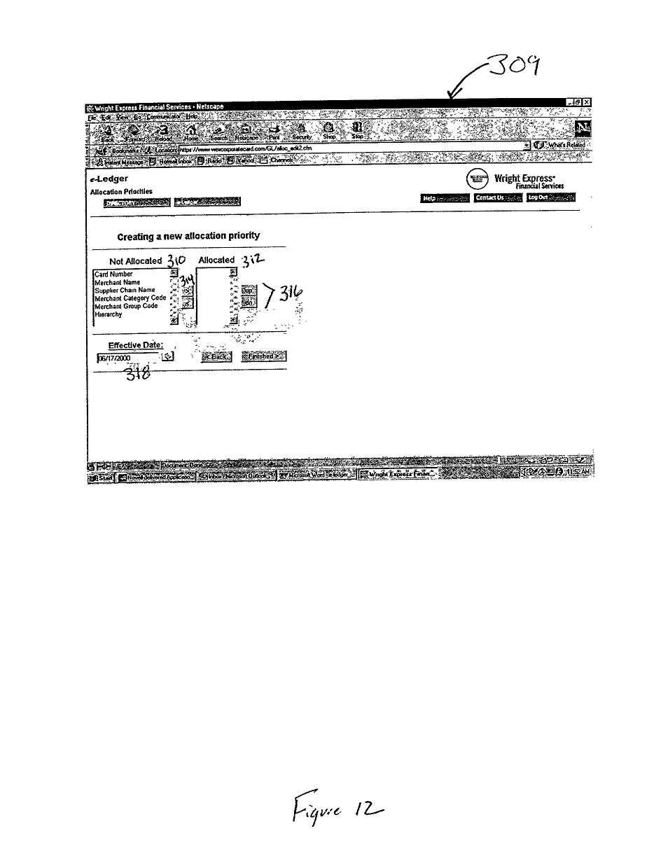

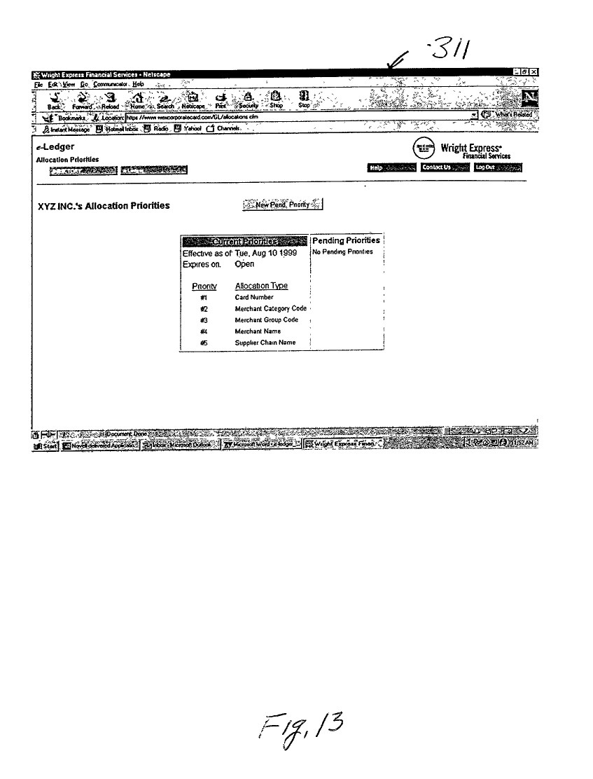

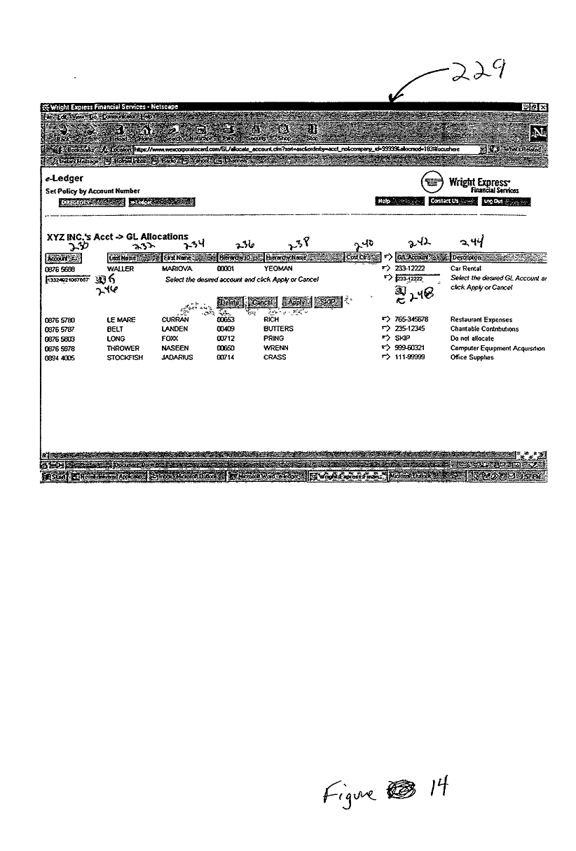

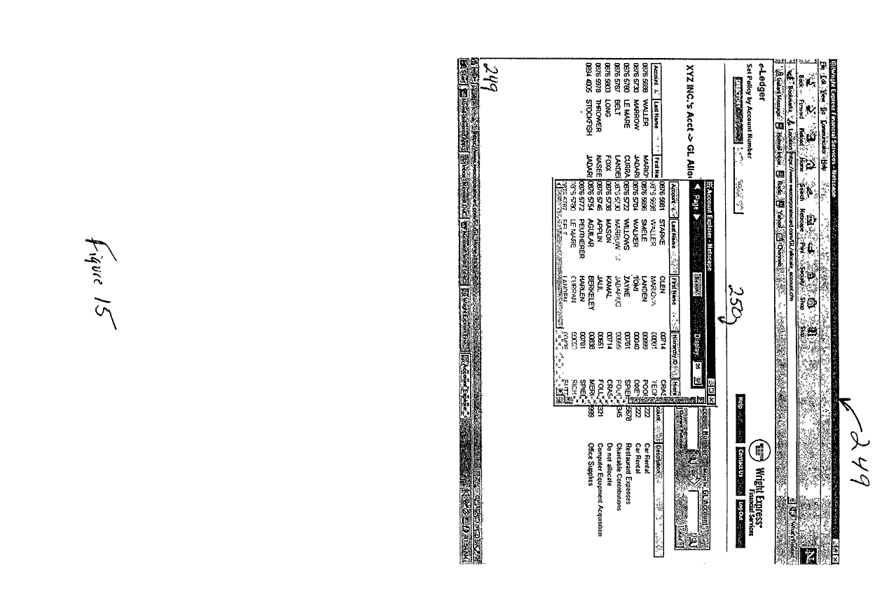

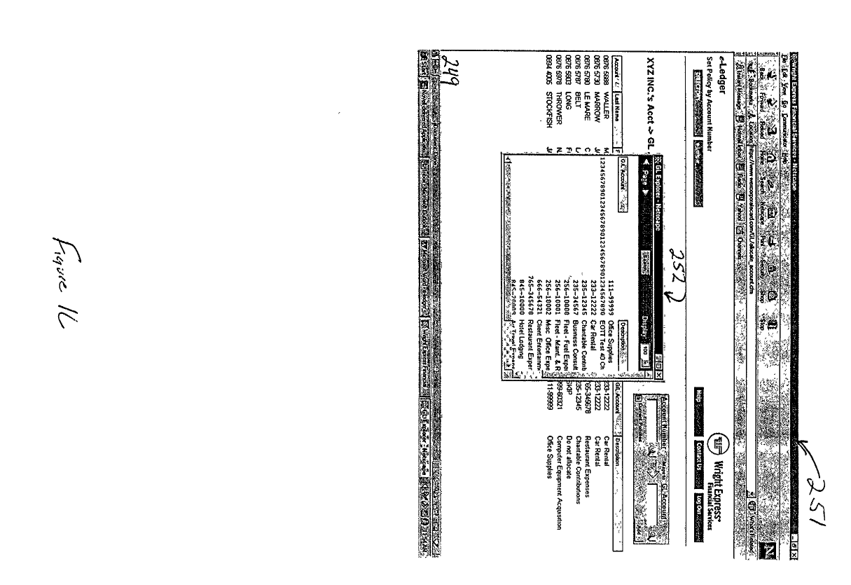

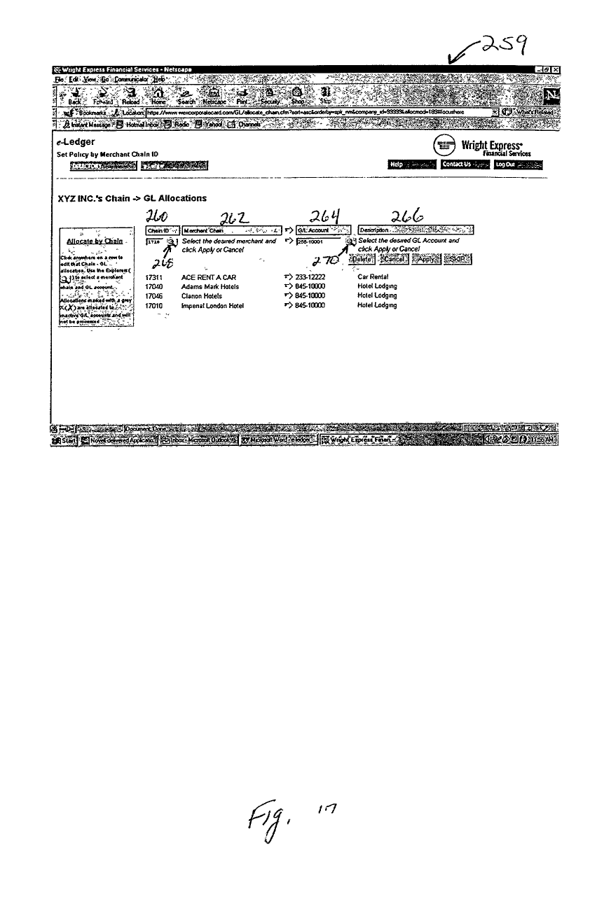

FIG. 4 depicts a policy engine, which is a process used to build a set of allocation rules that will determine on a transaction by transaction basis the desired general ledger account code that is assigned to a particular transaction and serves to correlate a particular transaction to its corresponding account of the ledger. Front end administration 519, which is shown generally in FIG. 4 and will be explained in detail with respect to FIG. 4b, generates the web pages used for policy creation/management. FIG. 4b, as will be described below, generates the web pages displayed in FIGS. 6 through 21. Cost centers 18c14, valid gl accounts 18c12, valid Merchant Category Codes (MCC) codes 18b7, valid merchant names 18b1 and company hierarchies 18c15 are tables where the indicated client defined data attributes are stored. Specifically cost centers, g1 accounts and company hierarchies are defined by the client and are assigned to each account. For example, company ‘A’ may request 1,000 accounts or charge cards to be created for the employees of company ‘A’. For each card generated, company ‘A’ will have an account 18c14 table entry created. The cost centers and company hierarchies are required attributes that are stored in the reference database 18c (tables 18c14 and 18c15 respectively). Additionally, the general ledger (GL) accounts are set up or defined by the client clicking on a web page 169 of FIG. 7 as displayed in step 508 of FIG. 4a. As an example, if company ‘A’ has fifty general ledger (GL) accounts, then all fifty accounts are required in the company_journal 18c12 table. In order to create mapping policies (FIG. 4), a chart of accounts must be constructed. This chart of accounts table (company_journal 18c12) is populated by step 514, which prompts the user to enter the data into a web page 189 (FIG. 9), as will be explained below. Finally, the MCC codes and merchant names are transmitted by each individual merchant via its terminal 60 (FIG. 3) to the database 18. For example, if an account holder uses his/her card at a fuel station, the merchant will transmit the resulting transaction from its terminal 60 via the master card network 61 and the card processor 62 to the database 18 of these data elements (MCC code, merchant name) as well as others relating to the financial transaction (e.g. sale amount, tax, merchant address, etc.).

Referring to FIG. 4, the GL mapping 18c13 is a table that relates each client defined attributes 18c14, 18b7, 18b1 and 18c15 to their general ledger account 18c12 and the account codes. In addition, the GL mapping rules 18c5 that guide this mapping and storage of attribute data in the GL mapping table 18c13 are also client defined. For example, if company ‘A’ would like to allocate all of their fuel charges to a particular account of the client's general ledger, then they would create this mapping table 18c13 by using step 533 (FIG. 4b) and web page 271 shown in FIG. 18. Transactions are allocated against these mappings of table18c13 utilizing a batch nightly process. The results (transaction dollar amount and GL accounting code ‘XYZ’) of the batch process are stored in the GL allocations table or transaction journal table 18b2 (as further shown in FIG. 5a).

FIGS. 5a, b and c describe the database table relationships which are used in the GL managing system 9. The reference database 18c comprises the tables 18c6, 18c14, 18c15 and 18c16, which are loaded with data transmitted from the card processor 62 as explained with reference to FIG. 3. The transactional database 18b includes the transactional tables 18bl through 18b7, which are created via the transactional data provided by the card processor 62. These transactional tables are used as input to the nightly batch allocation process. The reference database 18c further includes the tables 18c1, 18c2, 18c3, 18c4, 18c5, 18c7, 18c8, 18c9, 18c10, 18c11, 18c12 and 18c13 which are dependent on client input from its particular ledger applications and represent the storage of the client policy. These tables drive the policy portion of the client's particular application which will be better described below (FIGS. 6 through 21).

The initial step in the process of populating the database tables 18 of FIGS. 5a, b and c and of operating the ledger management system 9 of FIGS. 1 and 3, is the display of a web page 165 as shown in FIG. 6. This web page 165 is the primary or home web page and includes links for the four options of using and initializing the system 9, namely a ledger setup link 160, a ledger policy link 162, a transaction downloading link 164 and a transaction maintenance link 166. It is understood that the user actuates one of these links to move to a corresponding web page to facilitate the corresponding operation of the system 9, as will be explained in detail below.

FIGS. 4a, b, c and d are data flow diagrams depicting the flow of data process for the GL managing system 9. FIG. 4a shows a process 500 of setting up the GL managing system 9. In order to call the process 500, the user actuates the ledger setup link 160 presented by the web page 165 (FIG. 6). Then, step 501 initiates the process 500, before step 502 displays the GL managing system setup menu web page 169 (FIG. 7), which permits the user to set up the company's fiscal calendar in step 506, general ledger codes in step 508 and projects in step 510. Setting up the fiscal calendar and the chart of accounts is mandatory, whereas setting up the projects is optional. Each of these setup procedures is associated with a corresponding “fiscal calendar” link 170, an “accounting codes” link 172 or a “projects link” 174, which are presented by the web page 169.

Referring now to FIG. 4a, the user actuates in step 504 one of these links to select a corresponding one of the set up procedures in steps 506, 508 and 510. If setting up the fiscal calendar was selected in step 504, then step 506 facilitates the user's set up in step 512 of a fiscal calendar by displaying a web page 179 as shown in FIG. 8. Step 512 affords the user the ability to create his/her own custom fiscal calendar. Potentially, each period can be defined by the user. The web page 179 contains a description in column 188 of each fiscal period as well as a start date in column 184 and end date in column 186. In particular, the download complete column 188 displays a check if the allocated transactions have been downloaded or “completed” for the corresponding account. A user associated with a particular company is responsible for creating and maintaining the fiscal calendar. The purpose of the fiscal calendar is to define a period of time that matches that of the company's predefined fiscal period. The fiscal calendar is physically stored in table acctg_period 18c3 (FIG. 5b).

If the user selects the accounting codes procedure by actuating in step 508 (FIG. 4a) the fiscal calendar link 170, then step 508 generates and displays the chart of accounts on web page 189 (FIG. 9). The web page 189 allows the user to define each and every general ledger accounting code that will be used in the allocation process as described below. The step 508 opens the web page 189 to facilitate the user's inputting in step 514 the accounting codes in column 190, the corresponding definition of the account in column 192, and a check or indicator in column 194 of whether or not the account is active. The indicator option is only used if an account is no longer used by the company/client. The accounting codes are physically stored in table company_journal 18c12 (FIG. 5b).

If the user has actuated the “projects” link 174 (FIG. 7) and the corresponding web page 199 is displayed as shown in FIG. 10, the user is facilitated to create its own project. In particular, the user can enter its own Ids in column 200 and a brief description of each project in column 202. The Ids and description data of the projects are physically stored in table project table 18c2 (FIG. 5b). Defining projects in step 516 (FIG. 4a) is completely optional. If projects are defined, they will be displayed during the transaction maintenance process 559 as will be explained below with respect to FIG. 4d. The projects are designed to allow the user the ability to assign in step 516 another code to each transaction. This will be further explained when discussing transaction maintenance process 559.

Selecting option 162 of setting up the GL from FIG. 6 will start the policy definition for each company (step 520). FIG. 4b illustrates a method 519 by which each company can set up a GL policy according to its needs. A user can access the GL setup policy method 519 by clicking on the “ledger policy” link 162 (FIG. 6). In step 522, the user brings up the GL policy setup web page 518, as shown in FIG. 11. The web page 518 displays a main menu for the policy definition. There are five primary ways to allocate a financial transaction. The web page 518 presents for each such way a link, namely, an account link 212, a merchant chain link 214, a merchant category/group code link 216, a merchant name link 217 and a hierarchy link 220. Additionally, there is required a link 210 that permits the user to set the priority between plural accounts 210 (step 526) and to determine which account has overriding capability. This will be further explained when discussing FIG. 12.

Referring to FIGS. 4b and 11, the user may click in step 524 on one of the “create/edit” link 210, the “allocate by accounts” link 212, the “allocate by merchant chain” link 214, the “allocate by MCC” link 216, the “allocate to merchant name” link 218, the “allocate by hierarchy” link 220 or the “allocation summary” link 222 to select a corresponding one of the steps 526, 528, 530, 532, 534, 536 and 538, as shown in FIG. 4b, to create or edit a corresponding aspect of the client's policy. Further, each of these steps is processed and managed by the front end administration web page 518, as shown in FIG. 11.

To facilitate the construction or editing of the “allocate by account policy” procedure, the user actuates the “allocate by account” link 212 (FIG. 11), whereby step 528 (FIG. 4b) displays a web page 229 as shown in FIG. 14. This web page 229 (FIG. 14) presents an “account” button 230, which the user may actuate in step 528 to thereby allocate in step 529 transactions by specific account numbers, of which, only the last 8 positions are displayed in step 529 for security purposes. Further, to help facilitate the process, additional information about the corporate card accounts are displayed in the following windows: last name 232, first name 234, hierarchy id 236, hierarchy name 238, and cost center 240. The user may select by clicking on an explorer button 246 (FIG. 14), which allows the user to use an account explorer window 250 presented by a web page 249 (FIG. 15) to search for specific accounts. Once the corporate account is identified, it must be assigned to a general ledger (GL) account which appears in the window 242 (FIG. 14). The user may use a general ledger account explorer window 252 as shown in FIG. 16, by clicking on an explorer button 248, which allows the user to use the general ledger account explorer window 252 of the web page 251 (FIG. 16) to help in finding the specific account. Additionally, a GL account description window 244 is displayed on the web page 229 (FIG. 14). This window 244 allows users to go back and edit or delete each allocation if desired.

To develop or edit the “allocate by merchant chain” policy, the user clicks on the “merchant chain” link 214 (FIG. 11) to move to step 530 (FIG. 4b), which displays in step 531 a web page 259 shown in FIG. 17. This web page 259 allows the end user to allocate transactions by merchant chain in step 531. The web page 259 has a merchant chain Id window 260, which can be used to display a list of the Ids of the current merchants or suppliers. The chain Id needs to be entered in the window 260. Additionally, the merchant chain name is displayed in a window 262 to help facilitate the process. Additionally, the chain needs to be allocated to a specific GL account number that appears in a window 264. The GL Description appearing in a window 266 is used for display purposes and the GL Explorer window 264 is used to display a list of valid GL accounts (and descriptions). This web page 259 allows users to go back and edit or delete each allocation if desired.

To develop the Merchant Category Code (MCC) policy, the user clicks on the link 216 (FIG. 11) whereby the process moves to step 532 (FIG. 4b) which displays the web page 271 shown in FIG. 18. This web page 271 facilitates the end-user to allocate transactions by entering in step 533 (FIG. 4b) specific merchant category code (MCC) into a window 272 or, for greater simplicity, merchant group code in the window 272 (FIG. 18). As with the other allocations, a GL Explorer window 282 is provided. Additionally, the user can actuate a button 280 presented by the web page 271 to permit use of a MCC/Merchant Group explorer to select the specific MCC code or merchant group code. MCC/Merchant Group descriptions are displayed in a window 274 to explain the allocation. A GL description is also displayed in a window 278. This web-page 271 allows users to go back and edit or delete each allocation if desired.

To develop or edit the allocation by merchant name policy, the user clicks on the link 217 presented by the web page 518 (FIG. 11), whereby the process moves to step 534 (FIG. 4b) which displays the web page 289 as shown in FIG. 19. FIG. 19 depicts the web page 289 when selecting “Allocation by Merchant Name” in step 534. This web page 289 allows the end-user to allocate transactions by specific merchant names in step 535. The user can actuate button a “merchant chain” 296 (FIG. 19) to employ the Merchant Name explorer and GL Explorers to locate the specific merchant/GL. This web page 289 (FIG. 19) allows users to go back and edit or delete each allocation if desired.

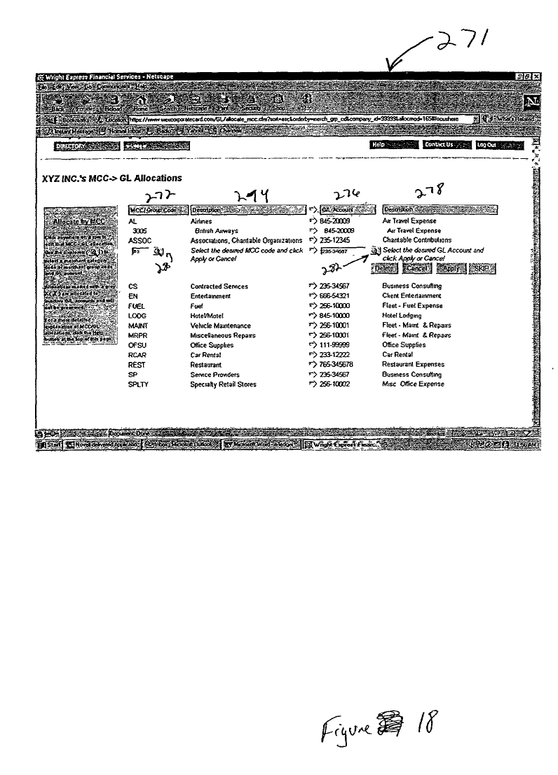

The user clicks on the link 220 (FIG. 11) to display in step 536 (FIG. 4b) a web page 299 (FIG. 20), whereby the user can develop the “allocate by hierarchy” policy. FIG. 20 depicts the web page 299 when it is selecting “Allocation by Hierarchy”. This web page 299 allows the end-user to allocate in step 537 (FIG. 4b) transactions by specific hierarchy. Hierarchy can be defined as the specific division, sub-division, branch, etc. of a company. The user may actuate button 308 (FIG. 20) to actuate Hierarchy and GL 310 explorers to locate the specific company hierarchies and GL accounts. This web page 299 allows users to go back and edit or delete each allocation if desired.

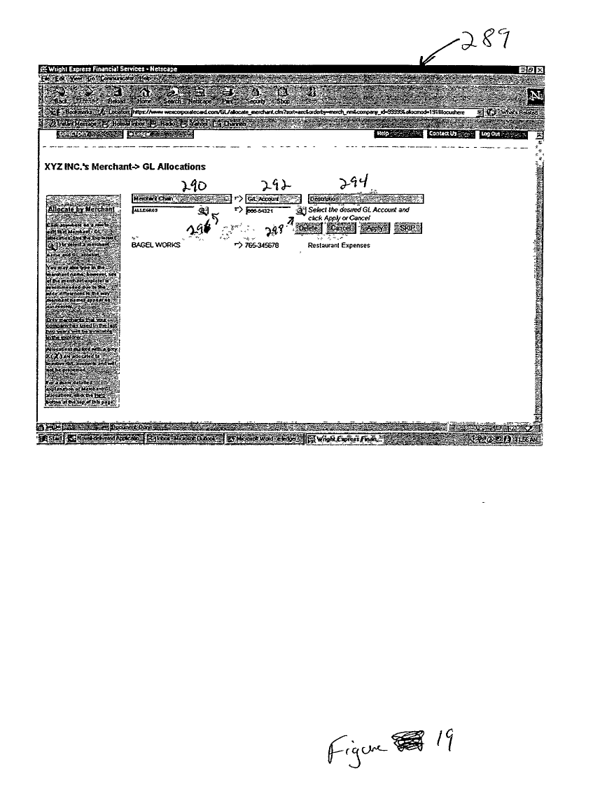

The user clicks in step 538 (FIG. 4b) on the link 222 (FIG. 11) to display in step 539 the web page 301 (FIG. 21) to facilitate the preparation in step 539 an allocation summary. FIG. 21 depicts a web page 301 when selecting the “Allocation Summary”. This web page 301 simply summarizes in step 539 all of the allocation policies which applies to a specific company.

The user actuates in step 522 (FIG. 4b) the link 210 (FIG. 11) to display in step 526 (FIG. 4b) web page 309 (FIG. 12) that facilitates the creating and editing in step 527 of the policy. FIGS. 12 and 13 depict the web pages 309 and 311 when selecting the “Create/Edit Policy”. These web pages 309 and 311 allow end-users to define the allocation types in window 310 and priorities in window 312 that the company will utilize in step 527. For example, if a company only allocates by hierarchy, then only hierarchy needs to be selected on the web page 309 (FIG. 12). If multiple allocation types are utilized (i.e. Merchant Name and Hierarchy), then a priority needs to be defined. This is required because it is possible that one transaction could actually fall into both allocation types. In this case, the priority defines which allocation type to use. The “>”, “<” buttons 314 (FIG. 12) are used to select the allocation type(s). The up, down buttons 316 are used to determine which allocation type has the highest priority. Additionally, the user needs to set an effective date of the priority. This is the date that the policy will take effect. FIG. 13 summarizes the policy priorities. All information from the policy definitions stated above in this section (Policy Creation and Policy Maintenance) are physically stored in tables company_alloc_priority 18c7, policy_specification 18c5, allocation_type 18c8 and allocation_specification 18c13 of FIG. 5b.

As an example, company ‘A’ may wish to allocate financial transactions by both MCC and by the number of the account. The company may wish that all transactions for executive employees be allocated to GL account number ‘ABC’ and, in addition, all fuel MCC codes be allocated to the GL account number ‘DEF’. In this example, it is possible that one transaction could represent both of these allocation types (e.g. an executive employee purchasing fuel). The create/edit policy is required to determine which policy types are being used (in this example Merchant Category Code and the Card Number) as displayed in window 310 (FIG. 12) of web page 309 and how to prioritize them by the up-down buttons 316. In this example, the card number policy type would be on top of the window 312 and Merchant Category Code would be on the bottom of window 312 thus giving the “allocate by account” policy the highest priority.

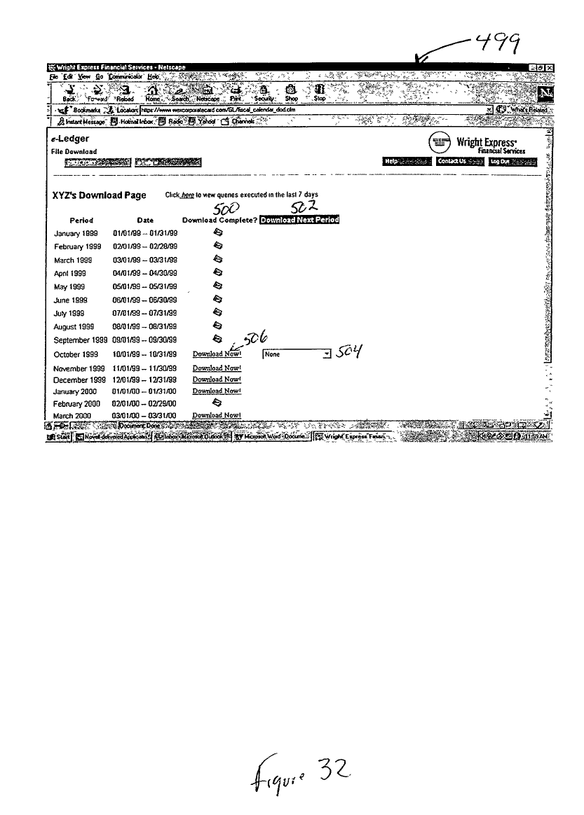

The user actuates a download link 164 of web page 165 (FIG. 6) to a process 549 (FIG. 4c), which permits one of the clients to selectively download a particular set of the processed transactions. In step 552, the user displays the transaction downloads on a web page 499 as shown in FIG. 32. The user selects in step 554 any of the “Download Now!” options 506 to begin the process of downloading in step 558 that fiscal period's data locally to the client's terminal 10 (FIG. 3). The items listed in window 504 of the web page 499 (FIG. 32) are created by a separate portion of the web site (not described in this document). However, it is important to note that the items contained in this list 504 (FIG. 32) are created by the end-user. When a fiscal period is complete, for example, the end-user actuates the transaction download link 164 as shown in FIG. 6. This option draws up web page 499 (FIG. 32) to download allocated data from that period locally to their client terminal 10 as shown in FIG. 3. To further explain, referring back to FIG. 6, the Transaction Download link 164 is clicked on to download all of the transactional data for a specified fiscal period. FIG. 32 displays in step 552 (FIG. 4c) the primary screen which shows the fiscal calendar. The primary function of the web page 499 (FIG. 32) is to select the fiscal period which the client would like to download. The web page 499 includes a Download Complete? column 500 that indicates whether the data for a particular period has been downloaded. The entry of a check in column 500 indicates that the data for that fiscal period has been downloaded. A “Download Now!” in column 500 indicates that this period has not yet been downloaded. The web page 499 also includes Download Next Period 502 column, which contains a drop down list box 504 next to the first period which has not yet been downloaded. The user must select one of the pre-defined queries/entries prior to clicking on the “Download Now!” link on button 506.

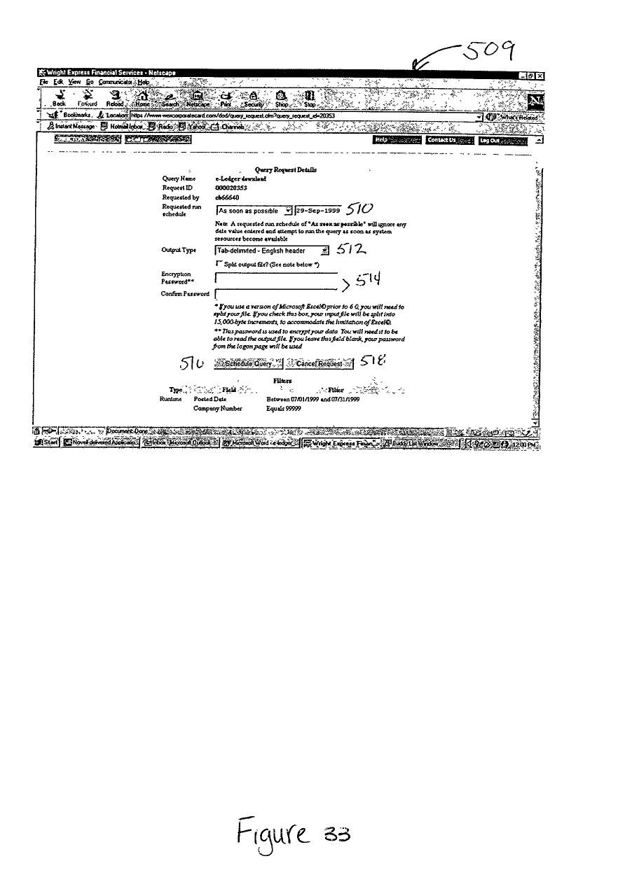

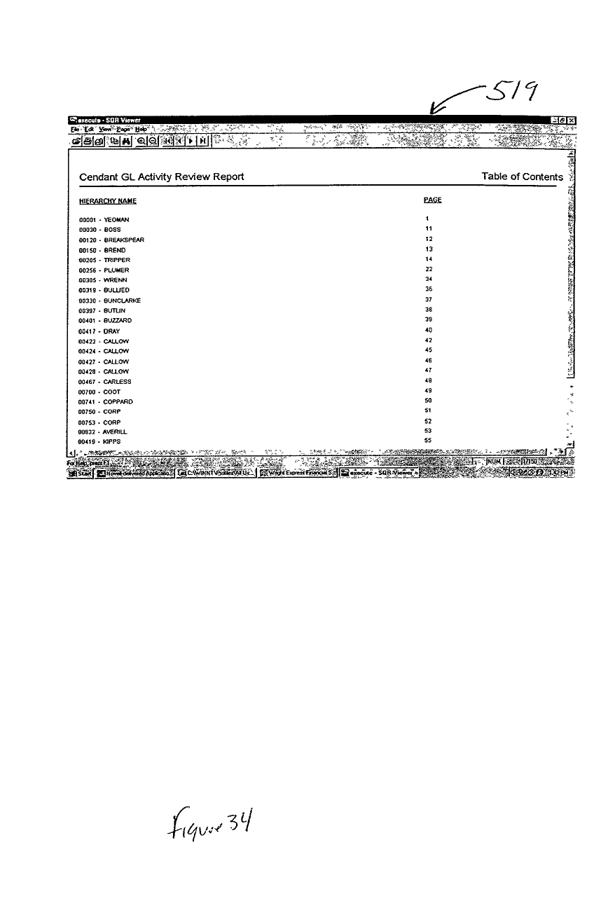

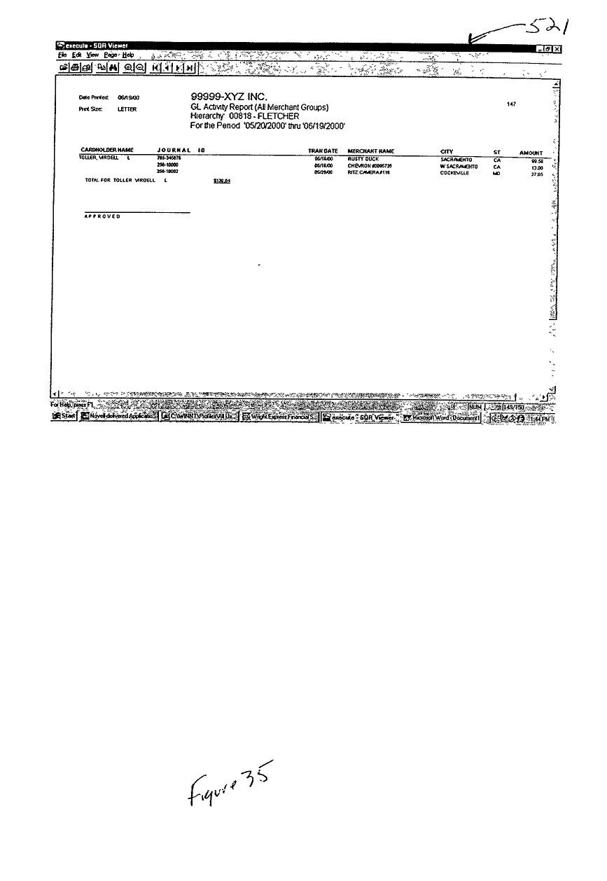

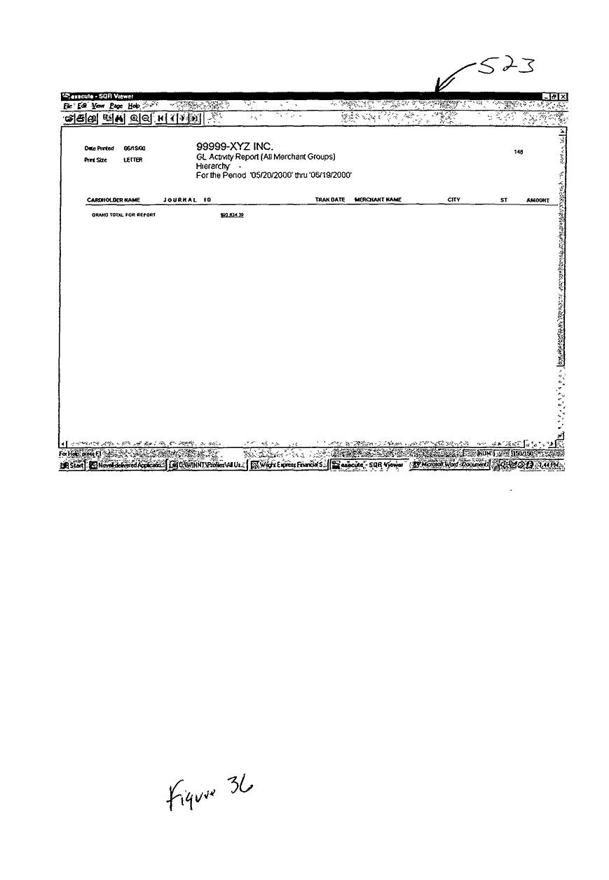

Clicking on the Download Now! link 506 will display a web page 509 as shown in FIG. 33, which asks the for the following information:

Requested Run Schedule 510 and enter the date that the query is to run. p1 Output type. Select one of the formats from the drop down list window 512.

Password. This information must be inputted in the window 514 in order to open the downloaded file.

Once the above information and user selections are completed, a schedule query button 516 is actuated to cause the query to execute. (Optionally, the end-user could actuate button 518 to cancel this query and return to the web page 499 of FIG. 32). At this point, the end-user will receive an e-mail notifying it when the query (creating the download file) is completed. Additionally, there will be an http link in the e-mail which can be clicked. This will start the download to the end-user's terminal 10 (FIG. 3).

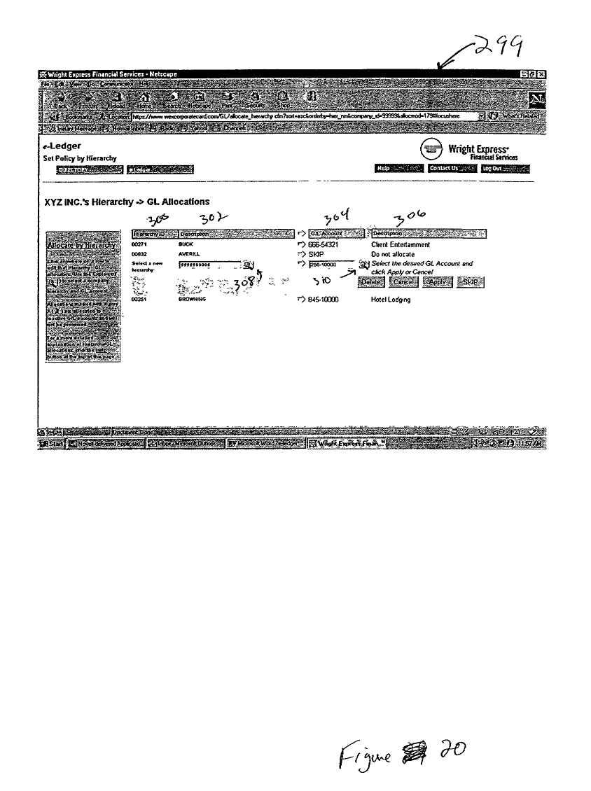

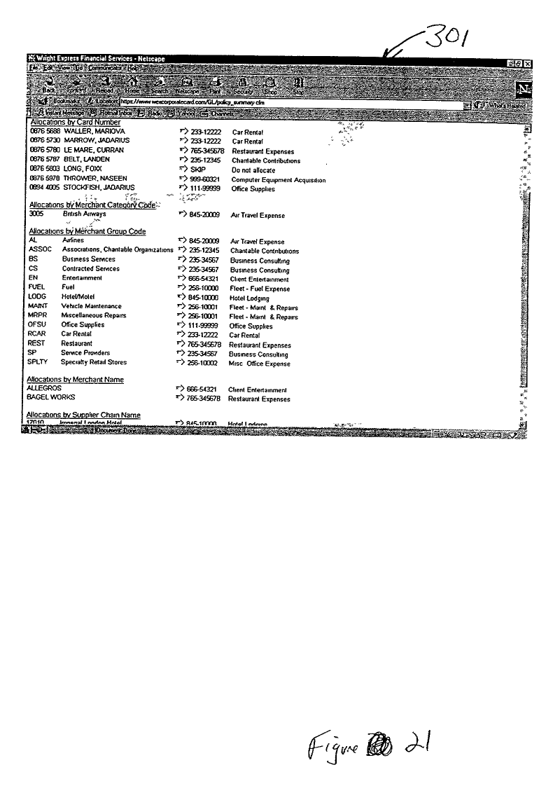

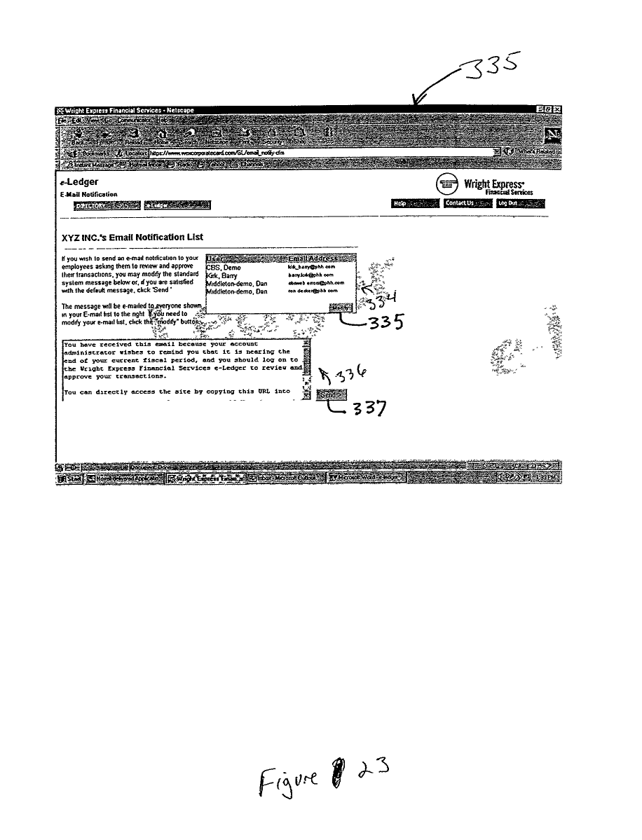

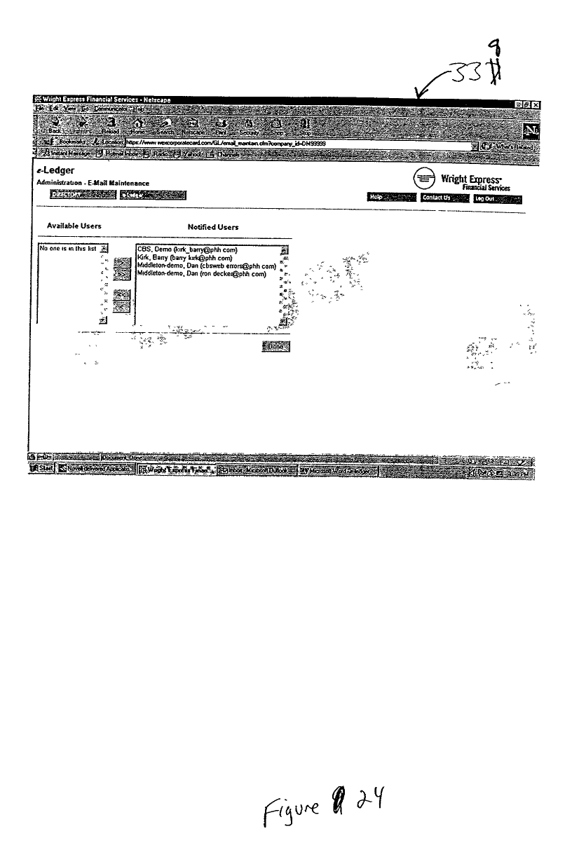

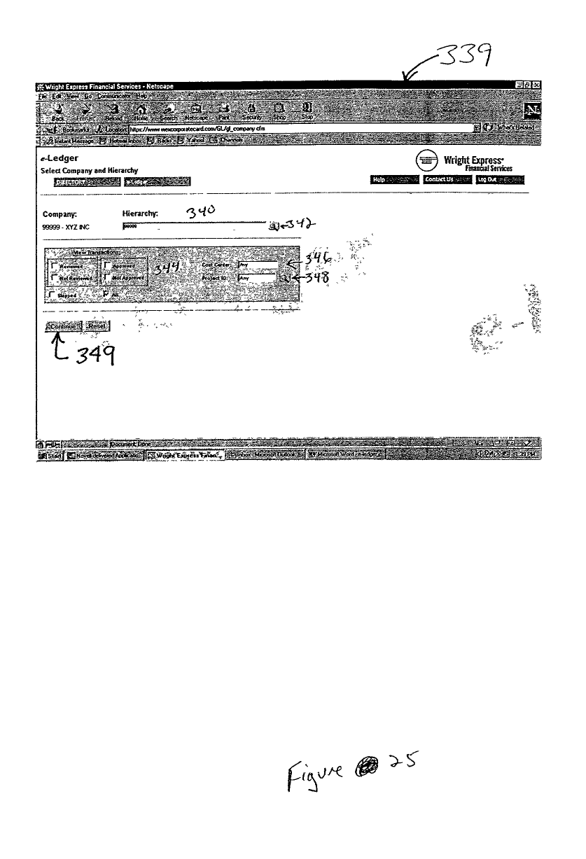

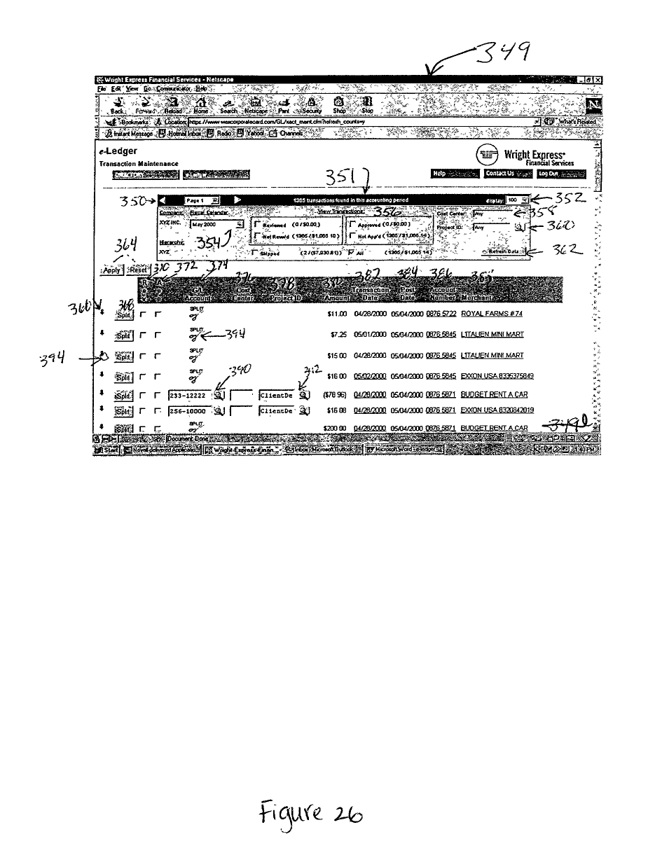

Next, the user actuates the transaction maintenance link 166 of web page 165 (FIG. 6) to move to the process 559 as shown in FIG. 4d for notifying a user that its data has been processed and is ready for the client's review and approval. First in step 562, the user displays the web page 329 bearing a transaction maintenance menu as shown in FIG. 22. This menu (FIG. 22) displays an “e-mail notify” button 330 and a “transaction maintenance” button 332. In step 562, the user is permitted to click on either of the buttons 330 or 332. If the user clicks on the “e-Mail notify” button 330, step 566 will draw a web page 335 as shown in FIG. 23. Step 566 affords the end-user the ability to add or remove e-mail addresses from the distribution list for the e-mail message. Step 566 allows the end-user to create their own message. The message displayed in FIG. 23 is simply a default message. If the transaction maintenance button 332 is clicked on, step 568 draws down a web page 339 as shown in FIG. 25. This web page 339 allows the end-user to limit the results returned on web page transaction maintenance web page 349 as shown in FIG. 26. The controls that the user has to limit this result set include a hierarchy explorer 342 (FIG. 25)(which limits the results to a specific section of the company), a specifying cost center window 346, a project Id window 348, and a set of transaction status buttons 344. Any and all combinations of these options will draw down web page 349 as shown in FIG. 26 when the “Continue” button 349 (FIG. 25) is clicked.

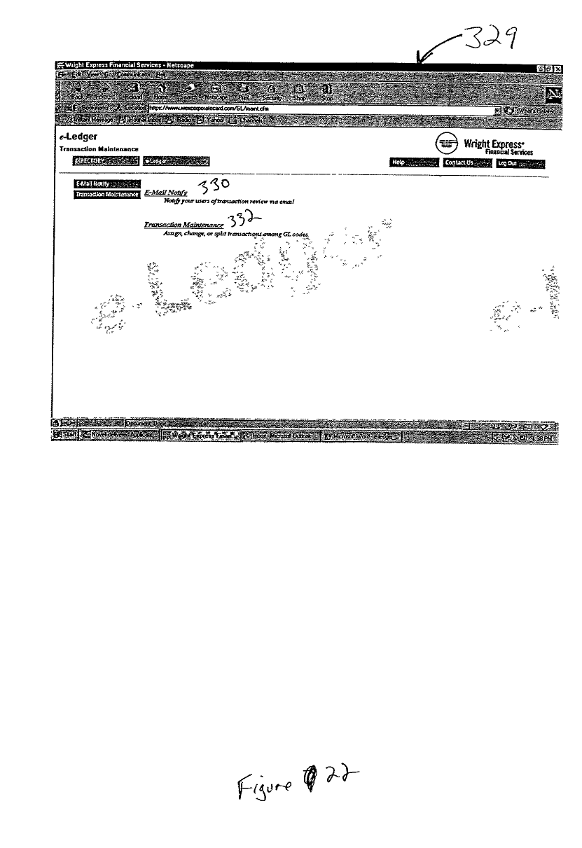

To further describe, referring to FIG. 6, actuation of the transaction maintenance link 166 will display the options necessary to maintain all allocated transactions (FIG. 22). The Transaction Maintenance menu screen (FIG. 22) has two options. First, step 566 (FIG. 4d) effects e-mail notification 330 (FIG. 22). This link is used to help facilitate sending e-mail reminders to those responsible for reviewing and approving transactions prior to the download in step 567. FIG. 23 displays in step 567 the web page 335 which is used for this purpose. First there is a list of e-mail recipients listed in a window 334 of the web page 335 which can be maintained by clicking on the “Modify” button 335. Additionally, you can create the text in a box 336 which you want sent to each responsible party. Clicking a “Send” button 337 will send the message. Additionally, step 566 displays the web page 338 which as shown in FIG. 24 illustrates how to maintain the company's e-mail notification list.

On a nightly basis, a backend batch process will utilize the company policy and allocation priority tables as described above (Policy creation and Policy Maintenance) to assign general ledger account numbers to the transactions. The result of this allocation will be stored in a transaction_journal table 18b2 (FIG. 5a). The primary source of data is a financial_transaction table 18b1 (FIG. 5a). Once the nightly process is completed, the transactions will then be available for a variety of functions described below via the Transaction Maintenance option initiated by clicking on link 332 (FIG. 22) to proceed to step 560 of the process 559 (FIG. 4d).

FIG. 25 depicts a primary filter web page 339, where the end-user has the ability to limit the number of transactions which will be displayed on the subsequent page. The following fields are available to limit the results:

Hierarchy window 340 (FIG. 25). A hierarchy explorer 342 can be used to drill down to the specific sub-division of the company of interest.

View Transactions boxes 344 (FIG. 25). This set of check boxes 344 can be utilized to limit the volume of data returned. The details of the contents of these check boxes will be described below.

Cost Center box 346 (FIG. 25). Entering a cost center in the box 346 here will limit the results to those charges which were applied against corporate card accounts containing the cost center entered here.

Project ID box 348 (FIG. 25). Entering a value or using the Project explorer to enter the value in the box 348 will limit the results to transactions which contain this project ID.

FIG. 26 depicts the Transaction Maintenance web page 349 that is generated in step 568 (FIG. 4d). This page 349 allows the end-user control over all allocations that were made during the batch allocation process in step 569. The top portion of the page 349 contains a set of boxes 350 through 362 which displays the following information:

Arrows 350. This control can be changed (via drop-down list box) to any other desired page. Alternatively, the left or right arrows 350 can be used to progress one page at a time forward or backward.

Total count 351. This total represents the total number of transactions during the selected accounting period.

Display 352. This drop-down list box can be used to change the number of entries which can be displayed on a page.

Fiscal period 354. The default fiscal period is the most recent fiscal period which has not yet been downloaded. Optionally, the fiscal period can be changed to look at a previous period.

View Transactions 356. This series of check boxes can be used to limit the results of the screen. In addition, there are displayed totals (number of transactions, total dollar amount) associated with each option.

Cost Center 358. This is the cost center which is associated with each transaction as it is allocated. Changing this value will limit the results of the page to those transactions which contain this cost center.

Project ID 360. This is the project Id that is assigned within this web page 349. Projects are not assigned during the batch allocation process. Entering a value here will limit the results to those which contain a project Id matching the value entered.

Refresh button 362. If any information is changed in the status boxes 350 through 362, this button 360 is required to be clicked in order for the new result set to be returned.

To further describe by example, company ‘A’ has a $400 transaction which was allocated to GL code ‘JKL’. The client may wish to actuate one of a plurality of “split” buttons 368 to split a particular transaction amount 380 and assign a portion of this charge to another GL account. Once they have completed the “split”, they must click on “apply” 364 button. This will cause a default batch allocation to be overridden in table transaction_journal 18b2 and/or table tran_jrnl_split 18b3 (FIG. 5a).

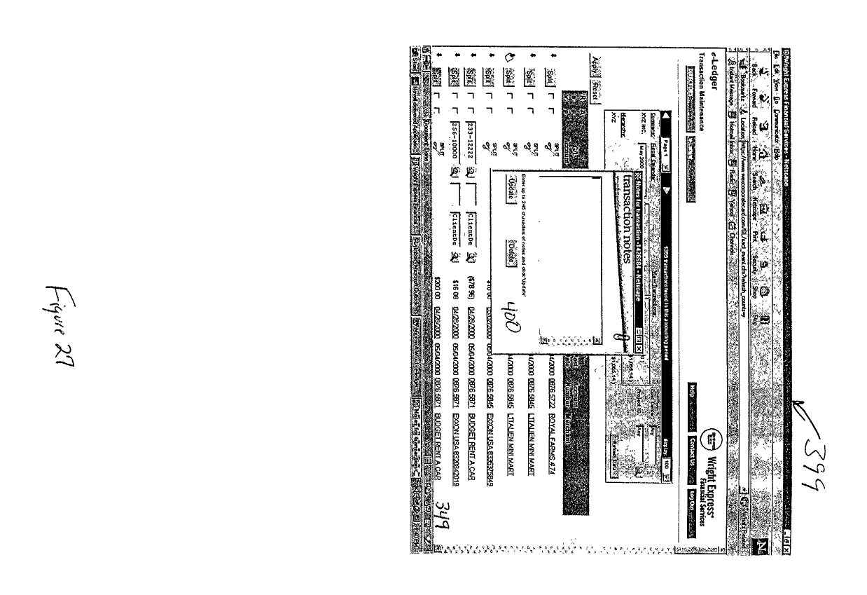

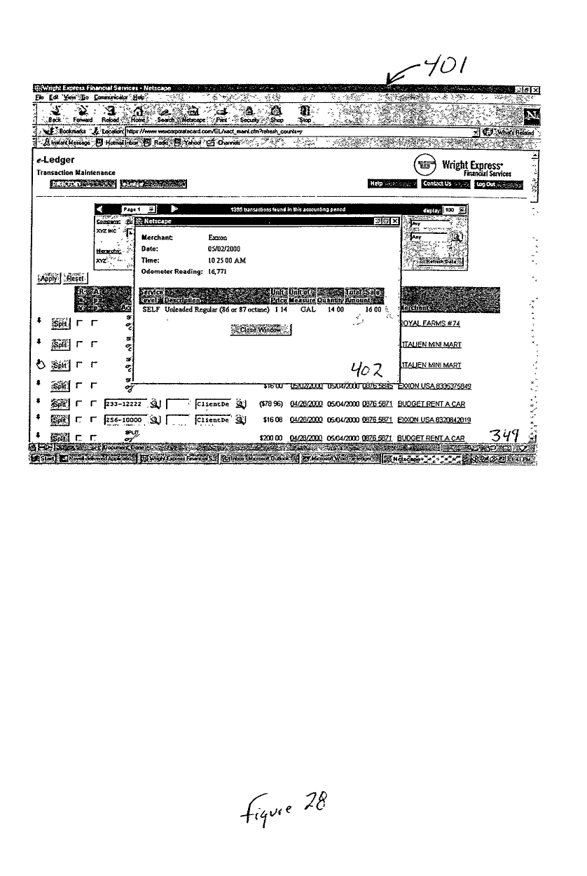

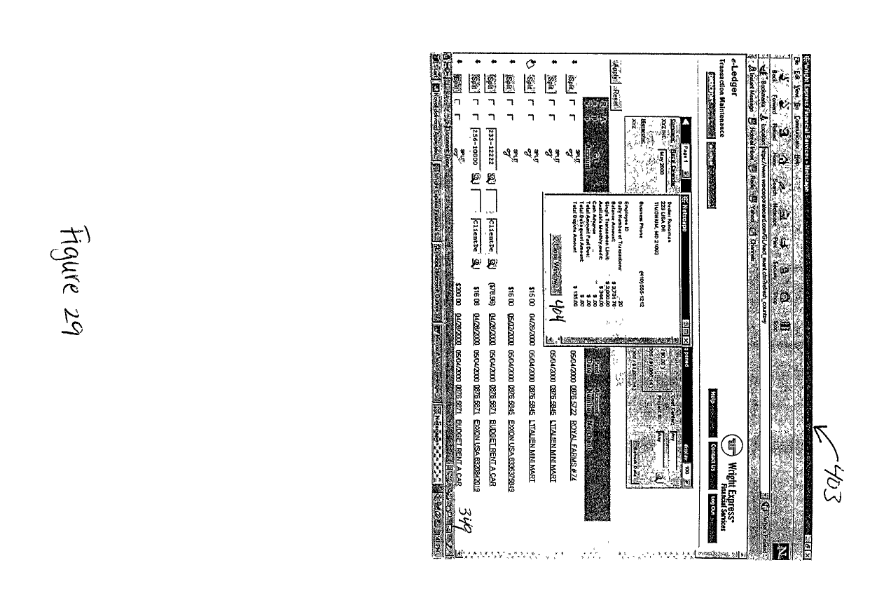

The remaining portion of the transaction maintenance page 349 (FIG. 26) displays the key parameters of each allocation. The general ledger account number window 374, cost center window 376 and project ID window 378 can all be modified here. Additionally, a note can be attached to each transaction by clicking on a thumb tack icon 366. Doing so, will pop up web page 399 with a new window 400 (FIG. 27). The new window 400, allows the user to enter any company specific information and save it with the transaction. Once the note is entered, the icon 366 (FIG. 26) is translated into a thumb tack with a note 394 (FIG. 26). Clicking on the underlined link for transaction date 382 (FIG. 26) will pop up web page 401 with a new window 402 (FIG. 28). The new window 402 displays additional details about the financial transaction. Clicking on the underlined link 386 (FIG. 26) for the Account Number will pop up web page 403 with a new window 404 (FIG. 29). The new window 404 displays details about the corporate card account holder. Clicking on the underlined link 388 for Merchant will pop up web page 405 with a new window (FIG. 30). The new window 406 displays additional details about the merchant.

Additionally, there are explorers 390 and 392 (FIG. 26), which will display a list of company defined general ledger account numbers and project Ids. Clicking on the apply button 364 will cause all modifications entered on this web page 349 to be updated on the transaction_journal table 18b2 (FIG. 5a).

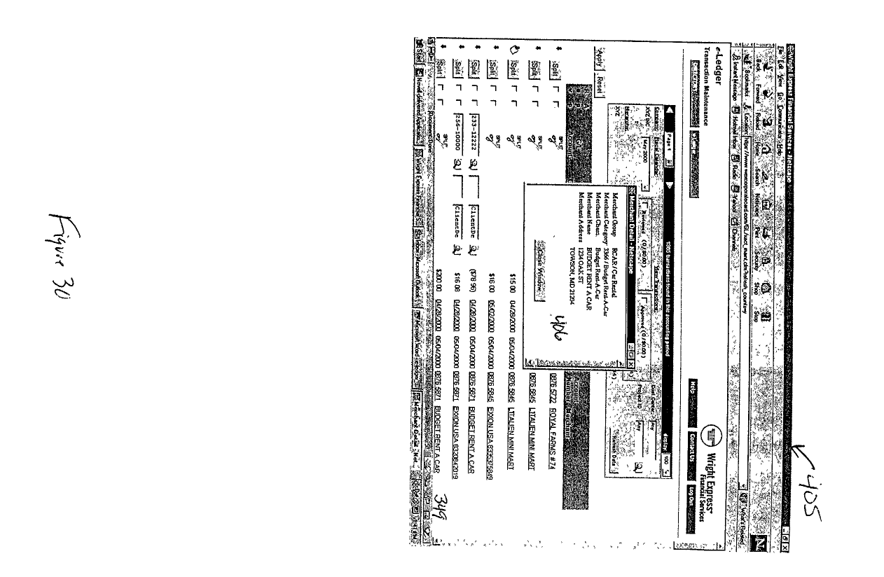

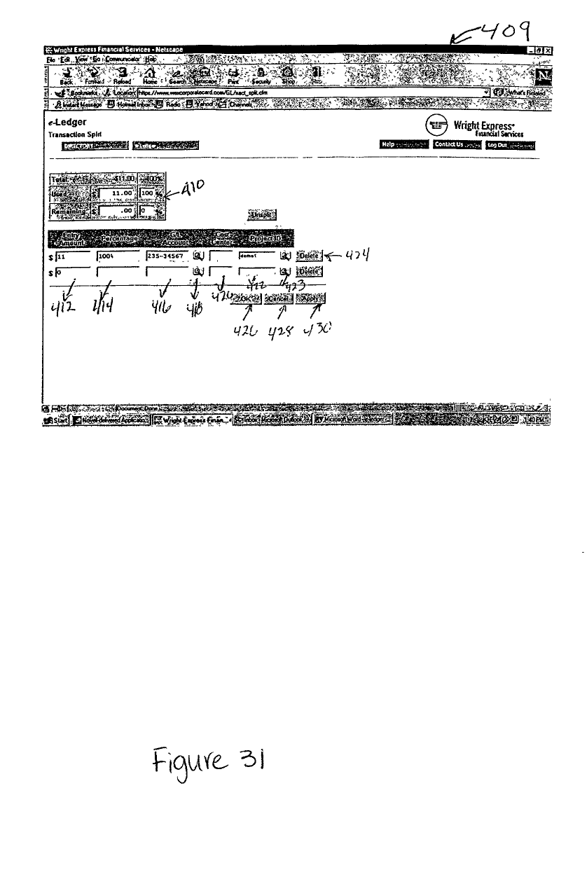

Further, there is an option to split the transactions up to 99 times. This function allows users to have a single transaction split across multiple general ledger account numbers, cost centers and project Ids. Clicking on one of the Split buttons 368 (FIG. 26) causes a new web page 409 to appear (FIG. 31). The details of this web page 409 are as follows:

Status box 410. This box is not intended for entry, it simply displays the total dollar amount of the transaction and the total percentage as well as total dollar amount remaining to be allocated.

Entry Amount and Percentage windows 412 and 414. The end-user can use either one of these windows to enter a portion of the total amount. Whichever field they use, the other will immediately reflect that change.

G/L Account window 416. This window 416 is the general ledger account value which the split amount will be applied.

G/L Explorer box 418. This box 418 is the general ledger explorer. It will pop a window displaying all valid general ledger account numbers.

Cost Center box 420. This box 420 is a free form field where the user can enter the cost center associated with the split amount.

Project ID box 422. This box 422 is the free form (optionally the user can use a project Id explorer 423) to enter the project which is associated with the split amount.

OK button 426. This button 426 will attempt to update all of the split amounts on this web page 409 back to the database table trans jrnl_split 18b3 FIG. 5a. If for some reason the dollar amount of the charge is not 100% allocated, a warning message will be generated.

Cancel button 428. This button 428 will cancel all operations made on this web page 409 and navigate back to the Transaction Maintenance page 349 (FIG. 26).

Apply button 430. This button 430 will take the information entered on the new open row and apply it to a working area. It will update the status box 410 and return a new open line. If the transaction is fully allocated, it will return to the prior web page 349 (FIG. 26).

Delete button 424. This button 424 will delete the single line item and update the status box 410 accordingly.

Once the split has occurred, the transaction maintenance web page 349 (FIG. 26) will display the GL, Cost Center, Project ID as a scissors image 394.

The Review and Approve check boxes 370 and 372 (FIG. 26) are available to the company to review and/or approve transactions by authorized personnel. The security to allow review/approve can be granted to which ever user's Id the plan administrator deems appropriate.

1. A method of allocating a plurality of financial transactions to a ledger of at least one user, the user's ledger comprising a plurality of accounts, each financial transaction having a set of attributes, said method comprising the steps of:
a) determining the attributes of each of said plurality of financial transactions;
b) facilitating the user's construction of its allocation policy, whereby certain of said attributes is/are correlated to corresponding ones of said plurality of said accounts; and
c) comparing said determined attributes of each of said plurality of financial transactions with said user's allocation policy to determine the matched attributes therebetween and allocating dependent on said matched attributes each financial transaction to a corresponding account of said user's ledger.

2. The method of allocating as claimed in claim 1, wherein said allocation policy includes a set of instructions.

3. The method of allocating as claimed in claim 2, wherein each of said plurality of transactions relates to selected of a plurality of sources and there is a plurality of users, and said method further comprises the step of responding to said set of instructions from a selected one of said plurality of users to communicate with and to instruct one of said plurality of sources to provide said set of instructions for allocation to said ledger of said one user.

4. The method of allocating as claimed in claim 1, wherein said attribute may take the form of one or more of the following group:
1) a particular one of a plurality of users,
2) one of a plurality of costs centers to which a financial transaction is allocated,
3) one of a plurality of merchants whose services or products were involved in one of said plurality of financial transactions, and/or
4) one of a plurality of classes of merchants whose services or product were involved in the financial transaction.

5. The method of allocating as claimed in claim 1, wherein there is further included a step of storing said allocation policy constructed in step b) in a memory to be available to be used in said allocation step c).

6. The method of allocating as claimed in claim 5, wherein step b) facilitates a plurality of users to construct and to store its own allocation policy in a storage location of the memory corresponding to its user.

7. The method of allocating as claimed in claim 1, wherein said allocation policy includes a set of rules, each rule correlating one or more attribute of a financial transaction with one or more account of a user's ledger.

8. The method of allocating as claimed in claim 1, wherein step b) further includes a sub-step of facilitating the user to construct each account of its ledger.

9. The method of allocating as claimed in claim 7, wherein step b) further includes the sub-step of assigning code to each rule that identifies each of the attributes that will satisfy that rule.

10. The method of facilitating at least one user to construct an allocation policy whereby each of a plurality of financial transactions may be allocated to a corresponding account of a ledger of the one user, each financial transaction comprising one or more attributes, said method comprising the steps of:
a) facilitating at least said one user to construct each account of said user's ledger;
b) selecting for each account a set of one or more of said attributes to be assigned to said corresponding account; and
c) constructing a plurality of rules against which each of the financial transactions is compared; and
d) assigning to each rule a set of attributes corresponding to one of the plurality accounts.

11. The method of facilitating at least one user to construct an allocation policy as claimed in claim 10, wherein said step d) further assigns to each rule one or more codes reflective of said set of attributes assigned thereto.

12. The method of facilitating at least one user to construct an allocation policy as claimed n claim 11, wherein said step d) further assigns a code representative of a user project to one or more of said user accounts that relate to said project.

13. The method of facilitating one of a plurality of users to manage a set of financial transactions of said one user, said method comprising the steps of:
a) facilitating said one user to construct a set of instructions as to how said set of financial transactions of said user are to be managed;
b) facilitating said user to set at least one fiscal period;
c) collecting said financial transactions that occurred during said fiscal period, and
d) processing said financial transactions that occurred during said selected fiscal period in accordance with said set of instructions.

14. The method of facilitating one of a plurality of users to manage a set of financial transactions as claimed in claim 13, wherein said set of instructions comprise a policy of allocating each of said financial constructions to a correspond account of a ledger of said user.

15. The method of facilitating one of a plurality of users to manage a set of financial transactions as claimed in claim 13, wherein a plurality of users is facilitated to manage a corresponding sets of financial transactions which are generated from different sources, said step b facilitating said user to set at least first and second fiscal periods, said step c collecting said first and second sets of financial data during said firs and second fiscal periods respectively, and step d processes said collected first and second set of financial transactions.

16. Apparatus for supporting a plurality of users to allocate the financial transactions of each user to a corresponding one of a plurality of ledgers, each of said plurality of ledgers having a plurality of accounts, said apparatus comprising:
a) a memory comprising a plurality of storage locations, each location for storing a corresponding one of said ledgers for its user; and
b) a server programmed to:
i) determining the attributes of each of the financial transactions;
ii) facilitating each of the plurality of users to construct its own allocation policy, and
iii) allocating each of the financial transactions according to the allocation policy of its user into a corresponding account of that user.

17. The apparatus for supporting a plurality of users as claimed in claim 16, wherein certain of said attributes is correlated to corresponding ones of said plurality of said accounts, and step c compares said determined attribute of each of said plurality of financial transactions with said user's allocation policy to determine the matched attribute there between and allocating each of said user's ledgers dependent on said matched attributes.

18. The apparatus for supporting a plurality of users as claimed in claim 16, wherein there is included a further memory, and said server is programmed to collect at a fiscal period set by the user an to store in said further memory a set of financial transactions, and to allocate each of the transactions of the set to a corresponding account of that user.

19. Apparatus for supporting each of a plurality of users to manage the card transactions made by the employees of each user, each user having its own computer terminal that is connected to and by a network to said supporting apparatus, the employees using a plurality of cards distributed by at least one card issuer, said apparatus comprising:
a) a memory comprising a plurality of storage locations, each storage location storing a corresponding card transactions of its user; and
b) a server coupled to the network and programmed to:
i) respond to a message from a particular user's terminal bearing a set of the user's instructions of how to process its card transactions and to download and store card transactions made by the employees of that user into a storage location of said memory corresponding to that user; and
ii) processing said downloaded card transactions of a particular in accordance with said instructions of that user.
